(19) United States
(12) Patent Application Publication
(10) Pub. No.: US 2009/0139912 A1
(43) Pub. Date: Jun. 4, 2009

(54) PAPER SHEETS PROCESSING DEVICE AND PAPER SHEETS PROCESSING METHOD

(75) Inventor: Hideto Yui, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/370,322

(22) Filed: Feb. 12, 2009

Related U.S. Application Data
(63) Continuation of application No. PCT/JP2007/062727, filed on Jun. 25, 2007.

(30) Foreign Application Priority Data
Aug. 14, 2006 (JP) 2006-221039
Aug. 14, 2006 (JP) 2006-221040
Aug. 14, 2006 (JP) 2006-221041

(51) Int. Cl. B07C 3/14; G06F 17/30

(52) U.S. Cl. 209/576; 707/104.1; 707/E17.019

(57) ABSTRACT

A sort device recognizes address information applied to paper sheets by an online OCR, collates a recognition result of this online OCR with address information stored in an address information database section, judges, based on a processing situation of another sort device capable of performing data communication with the sort device, whether or not to transfer images of the paper sheets to the other sort device in a case where the recognition result of the online OCR does not match any character information stored in the address information database section, recognizes the character information applied to the paper sheets from the images of the paper sheets by a recognizing process different from that of the online OCR in a case where it is judged that the images are not transferred, and transfers, to the other sort device, the images of the paper sheets judged to be transferred by the judgment.

### CROSS REFERENCE TO RELATED APPLICATIONS

This is a Continuation Application of PCT Application No. PCT/JP2007/062727, filed Jun. 25, 2007, which was published under PCT Article 21(2) in Japanese.

This application is based upon and claims the benefit of priority from prior Japanese Patent Applications No. 2006-221039, filed Aug. 14, 2006; No. 2006-221040, filed Aug. 14, 2006; and No. 2006-221041, filed Aug. 14, 2006, the entire contents of all of which are incorporated herein by reference.

### BACKGROUND OF THE INVENTION

1. Field of the Invention

The present invention relates to a paper sheets processing device which processes paper sheets based on character information applied onto paper sheets such as mail articles, and a paper sheets processing method.

2. Description of the Related Art

Heretofore, in a paper sheets processing device which processes paper sheets such as mail articles, the paper sheets are sorted based on sort information such as address information applied to the paper sheets. Moreover, in a sort system for delivering the mail articles based on the address information, the paper sheets processing devices installed in bases sort the paper sheets collected from a district in charge for each district based on a part of the address information. The paper sheets sorted for each district are conveyed to the bases of the districts. In the paper sheets processing device installed in the base which is a conveyance destination of the paper sheets sorted for each district, the paper sheets are sorted for each delivery destination of the district in charge based on the whole address information of the paper sheets.

For example, in the above-mentioned sort system, the base which collects and sorts the paper sheets for each base in charge is referred to as a central office (an acceptance office or a dispatch office), and the base which sorts the paper sheets from the central office in accordance with each delivery destination is referred to as a delivery office. Moreover, in the above-mentioned sort system, when the acceptance office sorts the paper sheets for each delivery office as minimum processing, the paper sheets can be conveyed to the delivery office in charge. However, in the conventional sort system, to efficiently perform the processing in the whole system, in principle, the paper sheets processing device of the acceptance office usually defines the sort information of the paper sheets. Therefore, in the paper sheets processing device of the acceptance office, with regard to the paper sheet from which the sort information cannot be identified in character recognition processing, a clerk performs an operation of inputting the sort information or the like. Moreover, in the paper sheets processing device, when character information such as address information can be recognized by the character recognition processing, a recognition result is collated with a plurality of pieces of address information beforehand stored in a database. As a result of this collation, in a case where the recognition result matches the information, the paper sheets processing device judges that the recognition result is correct.

However, the address information registered in the database is not constantly the latest registered address information. For example, when a building is newly constructed, an address of the building might not be registered in the database. Moreover, when a collective housing such as an apartment is newly constructed or when a house is newly constructed, corresponding address information is frequently not registered in the database. As a recognition result of such address information that is not registered in the database, it is judged that the recognition processing fails, although the processing is actually correct. In such a case, the address information of the paper sheets is manually input. Therefore, there is a problem that the processing is inefficient. Moreover, in the above sort system, in a case where an excessively large amount of the paper sheets is collected in a specific district, there is a problem that an excessively large processing load might be applied to the paper sheets processing device of the district.

### BRIEF SUMMARY OF THE INVENTION

According to one configuration of this invention, an object is to efficiently perform processing of sorting paper sheets based on sort information.

A paper sheets processing device according to one configuration of this invention comprises: a database in which various pieces of character information including specific character strings are stored; a reading section which reads images of paper sheets; a first recognizing section which recognizes the character information applied to the paper sheets from the images of the paper sheets read by this reading section; a collating section which collates the character information as a recognition result of this first recognizing section with each character information stored in the database; a judging section which judges, based on a processing situation of another paper sheets processing device that performs data communication with the paper sheets processing device, whether or not the images of the paper sheets are transferred to the other paper sheets processing device, in a case where this collating section judges that the character information as the recognition result of the first recognizing section does not match any character information stored in the database; a second recognizing section which recognizes the character information applied to the paper sheets from the images of the paper sheets by a process different from that of the first recognizing section, in a case where this judging section judges that the images of the paper sheets are not transferred; and a transfer section which transfers, to the other paper sheets processing device, the images of the paper sheets judged to be transferred by the judging section.

A paper sheets processing device according to one configuration of this invention comprises: a database in which various pieces of character information including specific character strings are stored; a reading section which reads images of paper sheets; an information input section which allows input of the character information applied to the paper sheets in a state in which the images of the paper sheets read by this reading section are displayed; a judging section which judges whether or not the character information input by this information input section matches the character information stored in the database; and a filing section which forms a file of the images of the paper sheets together with the character information input by the information input section, in a case where this judging section judges that the character information input by the information input section does not match any character information stored in the database.

A paper sheets processing device according to one configuration of this invention comprises: a database in which various pieces of character information including specific character strings are stored; a reading section which reads images of paper sheets; a recognizing section which recognizes the character information applied to the paper sheets from the images of the paper sheets read by this reading section; a collating section which collates the character information as a recognition result of this recognizing section with each character information stored in the database; an information input section which allows input of the character information applied to the paper sheets, in a case where this collating section judges that the character information as the recognition result of the recognizing section does not match any of the various pieces of character information stored in the database; a judging section which judges whether or not the character information input by this information input section matches the character information as the recognition result of the recognizing section; and a total section which totals the number of cases where this judging section judges that the character information input by the information input section matches the character information recognized by the recognizing section.

A paper sheets processing method according to one configuration of this invention comprises: reading images of paper sheets; recognizing, by a first recognizing process, character information applied to the paper sheets from the read images of the paper sheets; collating the character information as a recognition result with various pieces of character information stored in a database and including specific character strings; judging, based on a situation of another paper sheets processing device that performs data communication with the paper sheets processing device, whether or not to transfer the images of the paper sheets to the other paper sheets processing device, in a case where this collation judges that the character information as the recognition result of the first recognizing process does not match any character information stored in the database; recognizing the character information applied to the paper sheets from the images of the paper sheets by a second recognizing process different from the first recognizing process, in a case where this judgment judges that the images of the paper sheets are not transferred; and transferring, to the other paper sheets processing device, the images of the paper sheets judged to be transferred by the judgment.

A paper sheets processing method according to one configuration of this invention comprises: reading images of paper sheets; allowing input of character information applied to the paper sheets in a state in which the read images of the paper sheets are displayed; judging whether or not the input character information matches any of various pieces of character information stored in a database and including specific character strings; and forming a file of the input character information together with the read images of the paper sheets, in a case where this judgment judges that the input character information does not match any character information stored in the database.

A paper sheets processing method according to one configuration of this invention comprises: reading images of paper sheets; recognizing character information applied to the paper sheets from the read images of the paper sheets; collating the character information as a recognition result with various pieces of character information stored in a database and including specific character strings; allowing input of the character information applied to the paper sheets, in a case where this collation judges that the recognized character information does not match any character information stored in the database; judging whether or not this input character information matches the recognized character information; and totaling the number of cases where this judgment judges that the input character information matches the recognized character information.

### BRIEF DESCRIPTION OF THE SEVERAL VIEWS OF THE DRAWING

FIG. 1 is a diagram schematically showing a constitution example of a sort system according to embodiments;

FIG. 2 is a block diagram showing a constitution example of a sort device and the sort system according to the embodiments;

FIG. 3 is a flow chart showing a processing example of a sort device main body as a first embodiment;

FIG. 4 is a diagram showing a format example of coding data to be processed by a VCS section;

FIG. 5 is a diagram showing a format example of operating situation data;

FIG. 6 is a flow chart showing a processing example with respect to the coding data according to the first embodiment;

FIG. 7 is a flow chart showing a processing example in the VCS section according to the first embodiment;

FIG. 8 is a flow chart showing a processing example in a sort device main body according to a second embodiment;

FIG. 9 is a flow chart showing a processing example in a VCS section 30 according to the second embodiment;

FIG. 10 is a flow chart showing a processing example of paper sheets having ID codes printed thereon according to the second embodiment;

FIG. 11 is a diagram showing a constitution example of a data management device of a sort device according to a third embodiment;

FIG. 12 is a diagram showing a constitution example of an input information database according to the third embodiment;

FIG. 13 is a diagram showing a constitution example of a total data table according to the third embodiment; and

FIG. 14 is a flow chart showing a processing procedure with respect to paper sheets in dispatch sort processing of each sort device according to the third embodiment.

### DETAILED DESCRIPTION OF THE INVENTION

Embodiments of this invention will hereinafter be described in detail with reference to the drawings.

First, a constitution of a system according to the embodiments of this invention will schematically be described.

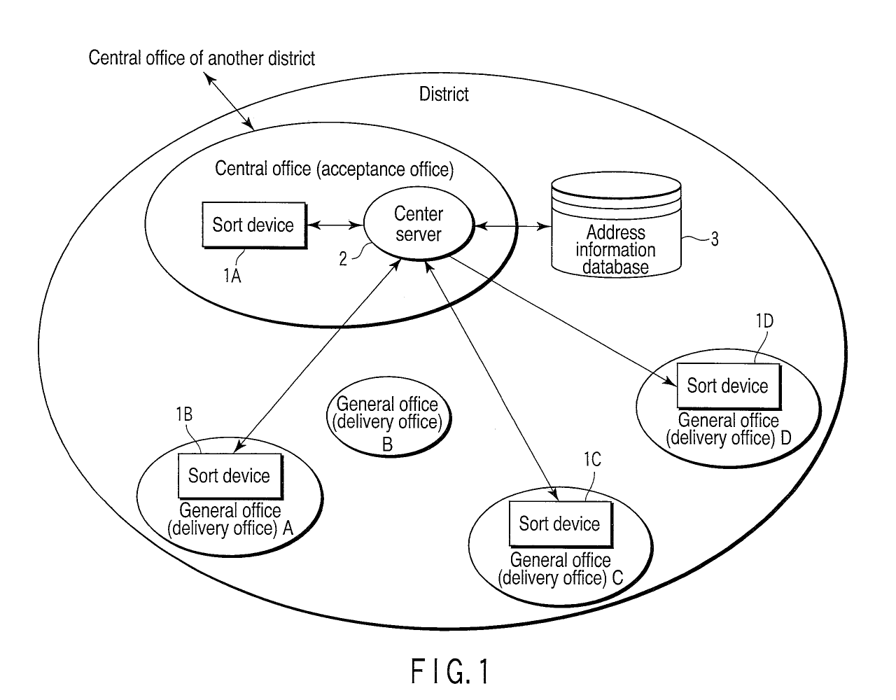

FIG. 1 is a diagram schematically showing a constitution example of a sort system according to the embodiments of this invention. The sort system according to the embodiments is constituted as, for example, a system in which systems individually provided in districts cooperate to cover all districts. That is, the sort system of each district cooperates with the sort system of another district to constitute the whole sort system which covers all the districts.

As shown in FIG. 1, the sort system provided in each district is constituted of one central office (an acceptance office) and a plurality of general offices (delivery offices) in charge of areas obtained by further dividing the district, respectively. In the constitution example shown in FIG. 1, the central office (the acceptance office) is provided with a sort device 1A. A general office (a delivery office) A, a general office (a delivery office) C and a general office (a delivery office) D are provided with sort devices 1B, 1C and 1D.

Each of the sort devices 1 (1A, 1B, . . . ) functions as a paper sheets processing device. Each sort device 1 is a device which sorts mail articles (delivery articles) as paper sheets based on sort information such as address information. It is to be noted that in the embodiments, as the sort devices 1 (1A, 1B, . . . ) as the paper sheets processing devices, devices for sorting the paper sheets based on the address information are assumed and described.

Moreover, the address information is constituted of information indicating a district (first information; e.g., prefectural and city governments, states, etc.), information indicating areas in the district (second information; e.g., a city, a town, a village, etc.), information indicating places in the areas (third information; e.g., a block number, a room number, etc.) and the like. Furthermore, at least a part of the address information is replaced with a numerical string (a zip code, a block number, etc.). For example, the information (e.g., upper three digits of the zip code) indicating the district as the first information and the information indicating the area of the district as the second information (e.g., lower four digits of the zip code) are represented by numerical strings each having a predetermined number of the digits, and the third information is represented by numerical strings such as the block number and the room number. In this case, the address information is represented by seven-digit number information (the zip code) as the first and second information and number information as the third information.

Moreover, the sort devices 1 (1A, 1B, . . . ) of the offices are connected to one another via a center server 2 so that data communication can mutually be performed. The center server 2 is connected to an address information database 3 in which the address information is stored. In consequence, each sort device 1 can access the address information database 3 via the center server 2. The address information database 3 may be provided in each sort device 1.

The central office generally controls the general offices in the districts. Each general office performs business of delivering the paper sheets addressed to the area in charge. Furthermore, the general offices include an office where the sort device for sorting the paper sheets is installed and an office where any sort device is not installed. The central office sorts the paper sheets addressed to the district and collected in another district or the paper sheets addressed to the district and collected in the district for each area of the general office in charge. The central office distributes the paper sheets sorted for each area to each general office. The general office sorts the paper sheets addressed to the area in charge in accordance with destination information. In each general office, the sorted paper sheets are delivered to the destinations.

It is to be noted that each general office may have a function of the acceptance office and a function of the delivery office, depending on a system constitution or an operating configuration. The sort device installed in the central office as the acceptance office performs processing (dispatch sort processing) of identifying information (information for specifying the delivery office) indicating the district or the area included in the address information of the collected paper sheets to sort the paper sheets based on the information. The sort device installed in the general office as the delivery office performs processing of sorting, in a delivery order or the like, the paper sheets addressed to the area in charge based on the address information of the paper sheets.

Next, constitutions of the sort device and the sort system according to the embodiments will be described.

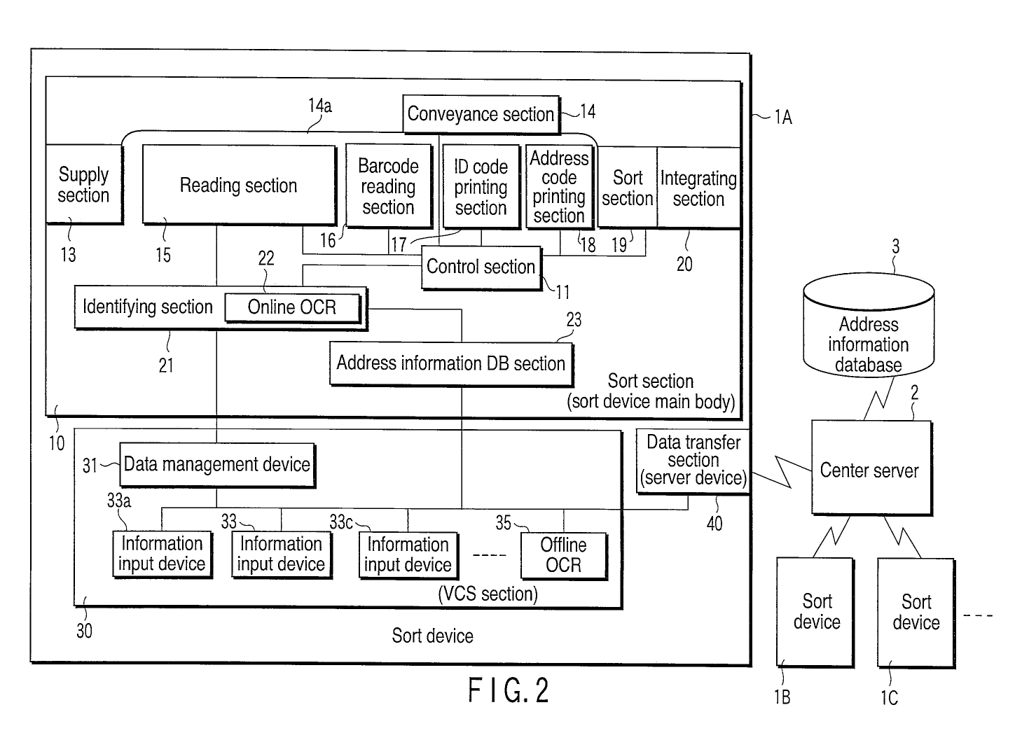

FIG. 2 is a block diagram showing a constitution example of the sort device 1 and the sort system according to the embodiments. As shown in FIG. 2, the sort device 1 is constituted of a sort section (a sort device main body) 10, a video coding system (VCS) section 30, a data transfer section (a data transfer server) 40 and the like.

As shown in FIG. 2, the sort device main body 10 has a control section 11, a supply section 13, a conveyance section 14, a reading section 15, a barcode reading section 16, an ID code printing section 17, an address code printing section 18, a sort section 19, an integrating section 20, an identifying section 21, an address information database section 23 and the like. As shown in FIG. 2, the VCS section 30 has a data management device 31, a plurality of information input devices (video coding disks: VCD) 33 (33a, 33b, . . . ), an offline OCR 35 and the like. It is to be noted that as shown in FIG. 1, the address information database section 23 may be provided in an external device communicable via the center server 2. In this case, the sort device 1 appropriately accesses the address information database 3 via the center server 2. In addition, here, as shown in FIG. 2, an example in which the address information database section 23 is provided in the sort device main body 10 will be described.

The control section 11 executes control of the whole sort device main body 10. The supply section 13 takes out the paper sheets (e.g., mail articles) as sort targets set by an operator one by one to supply the paper sheets to the conveyance section 14. The conveyance section 14 conveys the paper sheet taken by the supply section 13 to each section of the subsequent stage along a conveyance path 14a.

The reading section (a scanner) 15 is installed on a downstream side of the supply section 13 in a conveyance direction of the paper sheets along the conveyance path 14a. The reading section 15 reads an image of a surface on which the address information is described as sort information on the paper sheet taken by the supply section 13 and conveyed along the conveyance path 14a. The barcode reading section 16 reads barcodes printed on the paper sheets and indicating the address information or barcodes such as ID codes.

The ID code printing section 17 prints the ID codes as identification codes for identifying the paper sheets (or the images of the paper sheets read by the reading section 15) with respect to the paper sheets which are not provided with the barcodes indicating the address information. The address code printing section 18 prints the barcodes (address codes) indicating the address information described on the paper sheets. The address code printing section 18 prints the address codes on the paper sheets based on the address information identified by the identifying section 21, address information input by the information input device 33 or address information recognized by the offline OCR 35.

The sort section 19 sorts the paper sheets based on the address information. The integrating section 20 integrates the paper sheets sorted by the sort section 19. The integrating section 20 has an integration storage for integrating the paper sheets and a plurality of sort pockets (not shown). Each sort pocket is associated with a sort destination as the address information. That is, the paper sheets in which the address information has been defined are integrated in the sort pocket associated with the address information.

Moreover, the integrating section 20 has an integration storage for VCS (hereinafter referred to as the VCS integration storage) for integrating the paper sheets as processing targets of the VCS section 30, in which the address information has not been defined. That is, among the paper sheets in which the address information could not be defined, the paper sheets as the processing targets of the VCS section 30 are integrated in the VCS integration storage of the integrating section 20.

Furthermore, the integrating section 20 has an integration storage of non-destination paper sheets (hereinafter referred to as the non-destination integration storage) for integrating the paper sheets in which any sort pocket associated with the defined address information is not present. Here, the address information registered in the address information database section 23 is associated with any of the sort pockets. Therefore, the address information in which any associated sort pocket is not present is address information which is not registered in the address information database section 23. That is, the paper sheets of the address information which is not registered as the defined address information in the address information database section 23 are integrated in the non-destination integration storage.

The identifying section 21 identifies the sort destinations based on the address information of the paper sheets. The identifying section 21, for example, recognizes the address information from the images of the paper sheets read by the reading section 15 to identify the sort destinations of the paper sheets based on the recognized address information. With regard to the paper sheets on which the ID codes are printed, the address information corresponding to the ID code is read to identify the sort destinations of the paper sheets based on the address information. It is to be noted that the identifying section 21 may identify the sort destination indicated by the address information recognized by character recognition from the images of the paper sheets or identify the sort destination based on the address information corresponding to the ID code, depending on an operation mode beforehand set by an operator or the like.

The identifying section 21 has an online OCR (a character recognition device) 22. The online OCR 22 recognizes character information as the address information from the image of the paper sheet read by the reading section 15. The identifying section 21 judges whether or not a recognition result of the online OCR 22 matches any address information stored in the address information database section 23 to judge whether or not the recognition result of the online OCR 22 is definite address information.

Moreover, in the online OCR 22 of the identifying section 21, a recognition processing time (a limit time of recognition processing) for performing character recognition (recognition processing of the address information) is set in accordance with a conveyance time of the paper sheets in the sort device main body 10. That is, the online OCR 22 is constituted of such an algorithm that the recognition result of the character information as the address information is obtained within the recognition processing time (e.g., a time from when the paper sheet passes through the reading section 14 until the paper sheet reaches the address code printing section). The identifying section 21 transfers, to the data management device 31 of the VCS section 30, the image of the paper sheet from which the address information could not be recognized by the online OCR 22.

In the address information database section 23, the address information present as an address (a delivery destination) is stored. That is, the identifying section 21 judges whether or not a result of character recognition processing of the online OCR 22 is correct, based on the address information stored in the address information database section 23. In the address information database section 23, the address information is formed into the database for each district. The address information for each district is stored in the address information database section 23. For example, the address information of each district is associated with an update date and stored.

Moreover, the address information of each district stored in the address information database section 23 is appropriately updated in a case where a new address is set. Therefore, when update processing for registering newly set address information is not performed, the newly set address information might not be registered (updated) in the address information database section 23. In other words, when the update date is new, it is supposed that there is little unregistered address information in the address information of the districts. That is, it is supposedly preferable that the database of the address information has a new update date.

Next, a constitution example of the VCS section 30 will be described.

The data management device 31 functions as an interface between the sort device main body 10 and the information input device 33 or the offline OCR 35.

In the data management device 31, there is accumulated information (information for video coding) such as the image of the paper sheet from which the identifying section 21 judges that any address information could not be recognized. For example, in the data management device 31, the image of the paper sheet and a recognition result of characters as the address information obtained by the online OCR 22 are associated with ID information (an ID code) applied to the paper sheet and accumulated.

Moreover, the data management device 31 has a function of distributing, to each information input device 33 or the offline OCR 35, information for video coding (coding data) including the paper sheet image and the recognition result of the online OCR 22 associated with the ID information and the like, for each piece of paper sheet. In this function, the data management device 31 distributes the coding data in accordance with a situation of each information input device 33 or the offline OCR 35.

Furthermore, the data management device 31 has a function of allowing the data transfer section (the data transfer server) 40 to transfer the coding data to the other sort device. According to this function, the data management device 31 can transfer, for example, the information (the coding data) on the paper sheet from which the only information indicating the district can be recognized by the online OCR 22 to the sort device of the district indicated by the district information.

As described above, the data management device 31 has a function of selectively distributing the coding data in the VCS section 30 of the sort device 1 (e.g., 1A) (allowing the VCS 30 to process the data) and a function of selectively transferring the data to the other sort device 1 (e.g., 1B, 1C) (allowing the other sort device to process the data). Therefore, the data management device 31 has a function of judging whether the coding data is processed in the VCS section 30 (distributed to the information input device 33 or the offline OCR 35 in the VCS 30) or in the other sort device 1 (e.g., 1B, 1C) (transferred to the other sort device). This judgment is performed based on situations of the sort device 1 (1A) and the other sort device 1 (1B, 1C). Control of such coding data will be described later in detail.

The information input device 33 (33a, 33b, . . . ) is a device via which the operator inputs the address information based on the information for video coding such as the image of the paper sheet distributed from the data management device 31. In one sort device, the data management device 31 is connected to a plurality of information input devices 33. In each information input device 33, a processing situation or the like is notified to the data management device 31, and an input operation of the address information is performed based on the information for video coding (the coding data) distributed from the data management device 31 in accordance with the notified processing situation. Furthermore, the information input into each information input device 33 by a clerk is accumulated in the data management device 31.

Moreover, each information input device 33 is constituted of, for example, a control section, a storage section, a display section, an operating section and the like. In each information input device 33, the image of the paper sheet in the information for video coding received from the data management device 31 is displayed in the display section, and input of the address information or the like by the operator is accepted in a state in which the image of the paper sheet is displayed in the display section. Furthermore, in each information input device 33, the input information input as the address information by the operator is transferred to the data management device 31, as processed data (coded information) associated with the ID code of the paper sheet.

The offline OCR 35 is a device which recognizes the character information as the address information by an algorithm different from that of the online OCR 22 based on the image of the paper sheet distributed from the data management device 31. In particular, in the offline OCR 35, a processing time of the recognition processing is not limited by a conveyance time of the paper sheets in the sort device main body 10 or the like. Therefore, in the offline OCR 35, the recognition processing can be performed by a sophisticated or complicated algorithm different from that of the online OCR 22.

Moreover, in the offline OCR 35, it is judged whether or not the recognition result of the offline OCR 35 matches with any address information stored in the address information database section 23 to judge whether or not the recognition result is definite as the address information. Therefore, the offline OCR 35 notifies the data management device 31 of the recognition result of the character recognition processing performed by itself and information indicating whether or not the recognition result is definite as the address information.

Furthermore, the data management device 31 also has a function of accumulating the information input by the information input device 33, the recognition result obtained by the offline OCR 35 and the like. The data management device 31 supplies, to the sort device main body 10, the accumulated data (the information input by the information input device 33 or the recognition result obtained by the offline OCR 35). In the sort device 1 having such a constitution, the sort device main body 10 sorts the paper sheets based on the processed data accumulated by the data management device 31. For example, with regard to the paper sheets into which the address information is input by the information input device 33 (or the paper sheets from which the address information could be recognized by the offline OCR 35), the sort device main body 10 reads the ID code applied to the paper sheet, acquires the address information (the input information) of the paper sheet corresponding to the ID code from the data management device 31, and sorts the paper sheet based on the acquired address information.

It is to be noted that the data management device 31 may total the number of cases where the recognition result obtained by the online OCR 22 matches the information input by the information input device 33 (or the recognition result obtained by the offline OCR 35). Such totaled data is usable in evaluating the address information database section 23. That is, such address information that the recognition result obtained by the online OCR 22 matches the information input by the information input device 33 is predicted as information which is not registered in the address information. In consequence, in a case where there are a large number of cases where the recognition result obtained by the online OCR 22 matches the information input by the information input device 33, it is indicated that many paper sheets provided with the address information which is not registered in the address information database section 23 have been processed.

The data transfer section 40 is an interface for performing communication with the center server 2. For example, when the image of the paper sheet, various data or the like is transferred to the other sort device 1, the data transfer section 40 transfers the data to the other sort device 1 via the center server 2.

Next, a first embodiment applied to the sort device and sort system will be described.

This first embodiment is applied to the sort device 1 and the sort system having the constitution shown in FIGS. 1 and 2. First, a flow of processing of the paper sheets according to the first embodiment applied to the sort device 1 and the sort system will schematically be described.

In this first embodiment, the processing in the sort device installed in each central office provided for each district will mainly be described. That is, the sort device of each central office performs processing (dispatch sort processing) of sorting the paper sheets collected in the district in charge for each district. Here, the central office which sorts the collected paper sheets for each district is referred to as the acceptance office. Moreover, the paper sheets subjected to the dispatch sort processing in the above-mentioned acceptance office are distributed to the central office or the general office of each district. In the sort device of the central office which has received such paper sheets or the general office, processing of sorting the paper sheets for each area of each general office in the district in charge or processing (delivery sort processing, routing assembly processing) of sorting the paper sheets in a predetermined order such as a delivery order is performed. As described above, an office which sorts the paper sheets subjected to the delivery sorting for each area of the district or each delivery destination is referred to as a delivery office.

As described above, in the sort system according to the first embodiment, the paper sheets subjected to the dispatch sort processing by the acceptance office are more finely sorted by each delivery office. Such a sort system is operated in accordance with a predetermined operation rule so as to smoothly and efficiently perform processing of the paper sheets in the whole system. In the first embodiment described below, in the dispatch sort processing of the acceptance office, at least the online OCR 22 performs processing of recognizing the whole address information.

Next, the processing of the sort device main body 10 according to the first embodiment will be described.

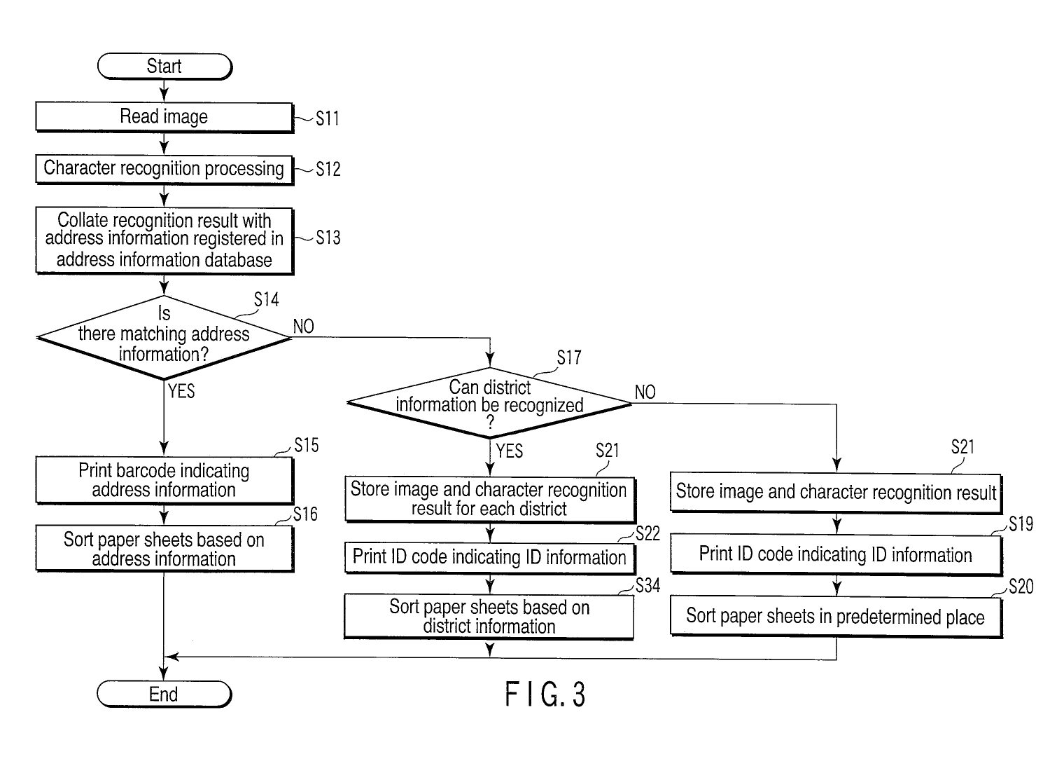

FIG. 3 is a flow chart showing a processing example of the sort device main body 10 as the first embodiment.

First, the clerk of the acceptance office sets the collected paper sheets to the supply section 13 of the sort device main body 10, and instructs starting of the dispatch sort processing via an operating section (not shown). Then, the control section 11 of the sort device main body 10 takes out the paper sheets set to the supply section 13 one by one to convey the sheet along the conveyance path 14a. Then, the reading section 15 reads the image on the paper sheet conveyed along the conveyance path 14a (step S11). This reading section 15 sends the read image on the paper sheet to the identifying section 21. In the identifying section 21, the online OCR 22 performs recognition processing (character recognition processing) of the address information based on the image of the paper sheet supplied from the reading section 15 (step S12). It is to be noted that with regard to the paper sheets on which the barcodes indicating the address information are printed, the address information is determined based on the barcode read by the barcode reading section 16.

When the recognition result is obtained by the online OCR 22, the identifying section 21 performs collation processing of the recognition result obtained by the online OCR 22 with the address information registered in the address information database section 23 (step S13). This collation processing judges whether or not the recognition result obtained by the online OCR 22 matches any address information registered in the address information database section 23 to judge whether or not the recognition result obtained by the online OCR 22 is correct. That is, the identifying section 21 judges whether or not the address information matching the recognition result obtained by the online OCR 22 is registered in the address information database section 23 (step S14).

It is to be noted that the above judgment judges whether or not the address information completely matching the recognition result obtained by the online OCR 22 is registered in the address information database section 23. In other words, the above judgment judges whether or not the whole address information can correctly be recognized by the online OCR 22. Therefore, as the recognition result obtained by the online OCR 22, when a part of the information can correctly be recognized (e.g., the only information indicating the district is correctly recognized), the above judgment judges that the recognition result obtained by the online OCR 22 is not the address information registered in the address information database section 23.

In a case where the above judgment judges that the address information matching the recognition result obtained by the online OCR 22 is registered in the address information database section 23 (step S14, YES), the identifying section 21 supplies, to the control section 11, the recognition result as the address information of the paper sheets. In consequence, the control section 11 defines, as the address information of the paper sheets, the address information as the recognition result from the identifying section 21. When the address information of the paper sheets is defined, the control section 11 converts the address information into the barcode. When the address information is converted into the barcode, the control section 11 allows the address code printing section 18 to print the barcode onto the corresponding paper sheet (step S15). In this case, the paper sheets on which the barcodes indicating the address information as the recognition result obtained by the online OCR 22 are printed are subjected to sort processing by the sort section 19 based on the address information (step S16).

Moreover, in a case where the above judgment judges that the address information matching the recognition result obtained by the online OCR 22 is not registered in the address information database section 23 (step S16, NO), the identifying section 21 judges whether or not information (first information) indicating the district in the character information as the recognition result obtained by the online OCR 22 can be recognized (step S17). It is to be noted that as described above, the information indicating the district is replaced with a numerical string of a plurality of upper digits in the address information (e.g., upper three digits in a seven-digit zip code). Moreover, here, information (second information) indicating a specific area in each district is replaced with a numerical string of predetermined digits (e.g., four lower digits in the seven-digit zip code), subsequently to the first information. On the other hand, the third information is sometimes represented by not only numerals but also various characters. When the first information and the second information are represented by the zip code, the first and second information can be identified by not only the address information described in characters on the paper sheet but also the zip code. Therefore, the information indicating the district (the first information) and the information indicating the area (the second information) in the address information have a recognition ratio higher than that of the information indicating the delivery destination in each area (the third information). In other words, even if the online OCR 22 cannot recognize the whole address information, the only information indicating the district in the address information can correctly be recognized.

In a case where the above judgment judges that even the information indicating the district cannot be recognized (step S17, NO), the identifying section 21 issues ID information with respect to the paper sheet. When the ID information is issued with respect to the paper sheet, the identifying section 21 performs processing of storing, in the data management device 31, the image of the paper sheet and the recognition result obtained by the online OCR 22 in association with the ID information of the paper sheet (step S18).

In this case, the identifying section 21 supplies, to the control section 11, the ID information of the paper sheet together with information indicating that the address information could not be recognized. Then, the control section 11 performs processing of converting the ID information into the barcode (the ID code), and allowing the ID code printing section 17 to print the ID code on the paper sheet (step S19). In this case, with regard to the paper sheet, even the information indicating the district cannot be identified. Therefore, the control section 11 performs processing of sorting the paper sheet in a predetermined place for integrating the paper sheets in which any district is not defined (step S20).

Moreover, in a case where the above judgment judges that the information indicating the district can be recognized (step S17, YES), the identifying section 21 issues the ID information with respect to the paper sheet. When the ID information is issued with respect to the paper sheet, the identifying section 21 performs processing of storing, in the data management device 31, the information indicating the district, the image of the paper sheet and the whole recognition result obtained by the online OCR 22 in association with the ID information of the paper sheet (step S21). In consequence, the data management device 31 can extract the image of the paper sheet and the recognition result for each district based on the information indicating the district.

In this case, the identifying section 21 supplies, to the control section 11, the ID information of the paper sheet together with the information indicating the district in the address information. Then, the control section 11 performs processing of converting the ID information into the barcode (the ID code), and allowing the ID code printing section 17 to print the ID code on the paper sheet (step S22). In this case, with regard to the paper sheet, the information indicating the district can be identified. Therefore, the control section 11 performs processing of sorting the paper sheets for each district based on the information indicating the district (step S23).

In the above-mentioned sort processing, the ID information is applied to the paper sheets for which the address information cannot completely be identified. Furthermore, among the paper sheets for which the address information cannot completely be identified, the paper sheets for which the district information can be identified are sorted for each district (delivery office). The images of such paper sheets are accumulated, in the data management device 31, as the coding data having the recognition result including at least the district information. Moreover, among the paper sheets for which the address information cannot completely be identified, the paper sheets for which even the district information cannot be identified are sorted in a predetermined place. Images of such paper sheets that the address information cannot completely be identified are accumulated as the coding data in the data management device 31.

According to the above-mentioned dispatch sort processing, among the paper sheets for which the address information cannot completely be identified, the paper sheets for which the information indicating the district can be identified can be subjected to the sort processing for each district. Moreover, the coding data in which the information indicating the district can be identified can be extracted from the data management device 31 for each district, and can be transferred to the sort device of another district (another sort device).

Next, a format example of the coding data will be described.

As described above, in the VCS section 30, the offline OCR 35 or the information input device 33 performs processing (video coding processing) of defining the address information of the paper sheets by use of the coding data including the ID information (mail ID), the images of the paper sheets, the recognition result obtained by the online OCR 22 and the like. The coding data is selectively distributed to the offline OCR 35 or the information input device 33 in the VCS section 30 of the sort system or the other sort device.

However, in the first embodiment, the transfer destination of the coding data is limited to the sort device provided in the district of the paper sheets (the district identified in accordance with the information indicating the district in the address information described on the paper sheets). Therefore, the coding data to be transferred to the other sort device includes the information indicating the district, which could be recognized by at least the online OCR 22.

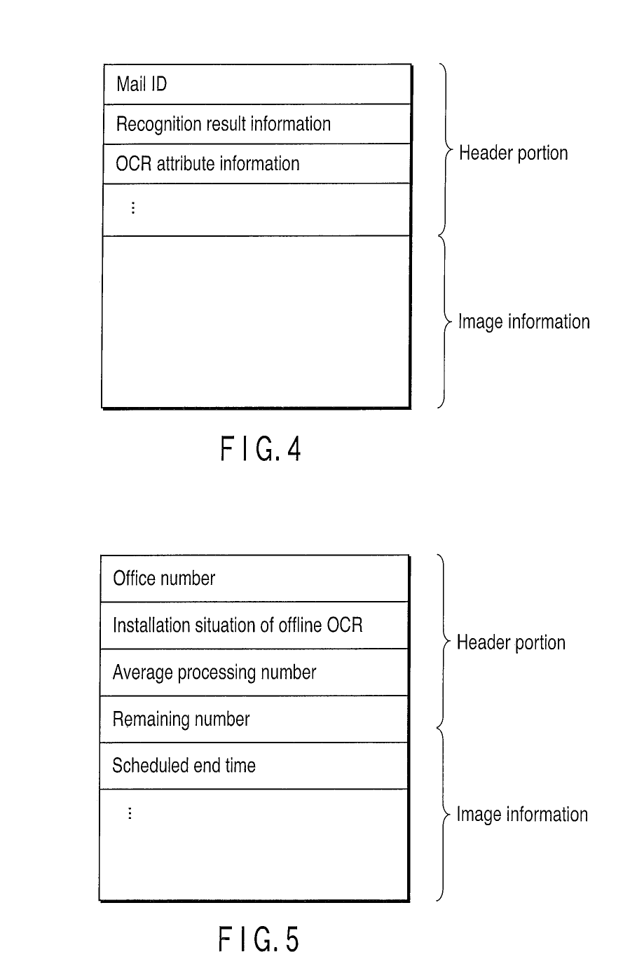

FIG. 4 is a diagram showing a format example of coding data to be processed by the VCS section 30.

As shown in FIG. 4, the coding data is constituted of a header portion including the mail ID (the ID information), recognition result information, OCR attribute information and the like, and an image information portion including image data of the paper sheets.

The mail ID is ID information applied to the paper sheets. The ID information as the mail ID is printed as the barcoded ID code on the paper sheets.

The recognition result information indicates the recognition result obtained by the online OCR 22. The coding data is generated in a case where the recognition result obtained by the online OCR 22 does not seem to be correct address information. Therefore, as the recognition result information, there is stored the recognition result obtained by the online OCR 22 in a case where it is judged that the result is not the correct address information, information of an only portion that can be recognized by the online OCR 22 or the like.

The OCR attribute information is information on the recognition processing executed by the online OCR 22. For example, as the OCR attribute information, there is stored information indicating a region where the images of the paper sheets are subjected to the recognition processing by the online OCR 22 or the like.

In the image information portion, the image data of the paper sheets read by the reading section 15 is stored.

According to the above format, in the coding data, information such as the mail ID, the recognition result information and the OCR attribute information can easily be identified together with the image data of the paper sheets.

Next, a format example of data indicating an operating situation of the offline OCR 35 in each sort device will be described.

In the first embodiment, in each sort device, the operating situation of the offline OCR 35 in the other sort device can be identified. For example, in each sort device, the operating situation of the offline OCR 35 of the other sort device is identified based on data (hereinafter referred to as the operating situation data) indicating the operating situation of the offline OCR 35 acquired by the other sort device. The operating situation data may periodically be acquired, or may appropriately be acquired if necessary.

Next, processing of the coding data according to the first embodiment will be described.

The coding data generated in the above dispatch sort processing is stored in the data management device 31. The data management device 31 judges a processing method of the stored coding data, and processes the coding data in accordance with the judgment. That is, the data management device 31 distributes the coding data including the images of the paper sheets from which the address information could not completely be recognized to the information input device 33 or the offline OCR 35 in the VCS section 30 of the sort device (the sort device of the acceptance office itself), or the device transfers the coding data to the sort device of the delivery office.

That is, the data management device 31 judges whether the coding processing of the coding data is executed by the VCS section 30 of the sort device of its own office or the sort device of the delivery office. This is judged based on the operating situation of the offline OCR in the sort device of its own office and the operating situation of the offline OCR in the sort device of the delivery office. Moreover, the data management device 31 acquires the operating situation data to inspect the operating situation of the offline OCR in the sort device of its own office.

FIG. 5 is a diagram showing a format example of the operating situation data.

As shown in FIG. 5, the operating situation data includes information such as an office number, the operating situation of the offline OCR, an average processing number, a remaining number and a scheduled end time.

The office number is identification information for identifying each sort device. The office number may be the information indicating the district. An installation situation of the offline OCR is information indicating the installation situation of the offline OCR in the sort system. As the installation situation of the offline OCR, for example, information indicating the presence of the offline OCR or a processing capability of the offline OCR is stored.

The average processing number is information indicating the average number of processing steps performed by the offline OCR of the sort device. For example, as the average processing number, information such as the number of the paper sheets processed by the offline OCR of the sort device within a predetermined time or the like is stored. The remaining number is information indicating the number of the paper sheets waiting for the processing to be performed by the offline OCR of the sort device. The scheduled end time is information indicating a scheduled time to end the processing performed by the offline of the sort device.

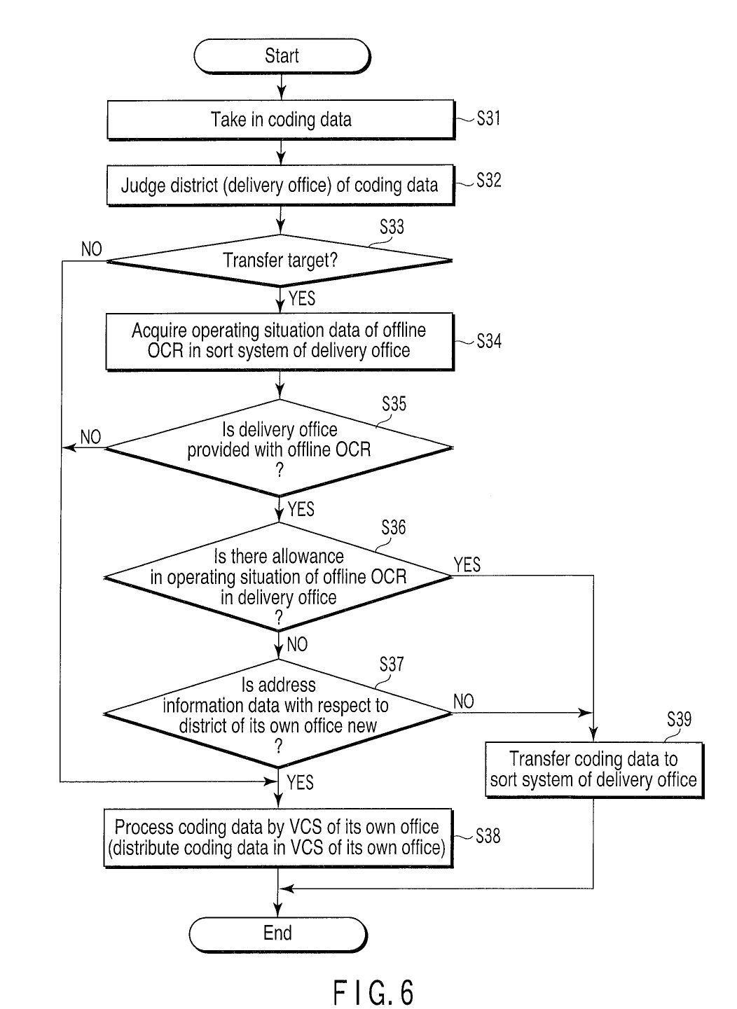

FIG. 6 is a flow chart showing a processing example with respect to the coding data according to the first embodiment.

The data management device 31 successively reads the stored coding data (step S31). Here, for example, the information of the header portion of each coding data is read. When the information of the header portion of each coding data is read, the data management device 31 judges the district (the delivery office) of the coding data based on the recognition result information (step S32). For example, when the information indicating the district is defined as the recognition result obtained by the offline OCR, the data management device 31 judges the district (the delivery office of the paper sheets) of the coding data based on the information indicating the district. Moreover, in a case where the information indicating the district is not defined, the data management device 31 judges that the district of the coding data is unclear.

Based on such judgment result of the district, the data management device 31 judges whether or not the coding data can be transferred to the sort device of the delivery office (step S33).

For example, in a case where the information indicating the district is not defined, that is, it is judged that the district (the delivery office) is unclear, the data management device 31 judges that the coding data cannot be transferred to the sort system of the delivery office. As described above, in the dispatch sort processing of the present sort device, the paper sheets are sorted for each district (delivery office) based on at least the information indicating the district. Therefore, with regard to the coding data of the paper sheets in which any district is not defined, the VCS section 30 of the sort device needs to define at least the district. Therefore, with regard to the coding data in which the district is unclear, it is judged that the data cannot be transferred to the other sort device (i.e., the data is process in the VCS section 30 of the sort device).

Moreover, in a specific district, it may be set in advance that any coding data is not transferred (or conversely, the district where the coding data can be transferred may be set). In this case, with regard to the district where any coding data is not transferred, the coding data is processed in the VCS section 30 of the sort device itself. Thus, the data management device 31 judges whether or not the information indicating the district indicates the specific district to judge whether or not the coding data can be transferred to the sort system of the delivery office.

In a case where the above judgment judges that the coding data can be transferred to the sort device of the delivery office (step S33, YES), the data management device 31 performs judgment processing for judging whether or not the coding data is transferred to the sort device of the delivery office (steps S34 to S38). It is judged whether or not each coding data is transferred, depending on the installation situation and the operating situation of the offline OCR in the sort device of the delivery office.

In the above judgment processing, the data management device 31 acquires the operating situation data indicating the operating situation of the offline OCR in the sort device of the delivery office (step S34). The operating situation data indicating the operating situation of the offline OCR in the sort device of the delivery office is constituted of, for example, the format shown in FIG. 5. Moreover, the operating situation data may periodically be acquired from the sort device of the delivery office, or may be acquired if necessary. Moreover, an operating configuration is possible in which the operating situation of the offline OCR in each sort system is managed by the center server 2. In this case, the center server 2 may return the operating situation data of each sort device based on inquiry from each sort system while monitoring the operating situation of the offline OCR in each sort device.

On acquiring the operating situation data, the data management device 31 performs various judgments for judging whether or not the coding data is transferred to the sort device of the delivery office, based on the acquired operating situation data (steps S35 to S38). It can be set that it is judged based on various judgment criteria whether or not the coding data is transferred to the sort device of the delivery office. Such judgment criteria are set so that the whole sort system can efficiently perform the processing based on the operating configuration. Here, as an example, there will be described a case where it is judged whether or not to transfer the data, based on the installation situation of the offline OCR, the operating situation of the offline OCR, an update situation of the database of the address information and the like.

In this case, the data management device 31 judges whether or not the sort device of the delivery office is provided with the offline OCR (step S35). In a case where this judgment judges that the sort device of the delivery office is not provided with the offline OCR (step S35, NO), the data management device 31 judges that the coding data is process by the VCS section 30 of its own office. In this case, the coding data is processed by the VCS section 30 of its own office (step S38). That is, the data management device 31 performs processing of distributing the coding data to the offline OCR 35 or the information input device 33 in the VCS section 30 of the sort device of its own office. In consequence, the VCS section 30 of the sort system performs processing of defining the address information based on the coding data.

Moreover, in a case where the above judgment judges that the sort device of the delivery office is provided with the offline OCR (step S35, YES), the data management device 31 judges whether or not there is an allowance in the operating situation of the offline OCR 35 in the sort device of the delivery office (step S36). For example, the data management device 31 judges whether or not there is an allowance in the operating situation, based on the average processing number, the remaining number or the scheduled end time in the operating situation data of the delivery office. Moreover, the data management device 31 may relatively compare the operating situation of the offline OCR of its own office with that of the offline OCR of the delivery office, to judge whether or not there is an allowance in the operating situation of the offline OCR of the delivery office.

In a case where the above judgment judges that there is an allowance in the operating situation of the offline OCR of the delivery office (step S36, YES), the data management device 31 judges that the coding data is processed by the VCS section 30 of the delivery office. In this case, the coding data is transferred to the sort device of the delivery office, and processed by the VCS section 30 of the delivery office (step S39). That is, the data management device 31 allows the data transfer section 40 to transfer the coding data to the sort device of the delivery office. In consequence, in the sort device of the delivery office, the VCS performs processing of defining the address information based on the coding data transferred from the other sort device.

Moreover, in a case where the above judgment judges that there is not any allowance in the operating situation of the offline OCR of the delivery office (step S36, NO), the data management device 31 further judges whether or not a database (address information data of the corresponding district) of the corresponding district stored in the address information database section 23 of the sort device of its own office is new (step S37). For example, the data management device 31 judges whether or not a period elapsed from a date (the latest update date) when the database of the district of its own office is last updated is a predetermined period or less to judge whether or not the database of the district of its own office is new. Moreover, the data management device 31 may compare the latest update date of the database of its own office with that of the database of the delivery office to judge whether or not the database of its own office is new.

In a case where the judgment judges that the database of the district of its own office is new (step S37, YES), the data management device 31 judges that the coding data is processed by the VCS section 30 of its own office. In this case, the coding data is process of the VCS section 30 of its own office (step S38). That is, the data management device 31 performs processing of distributing the coding data to the offline OCR 35 or the information input device 33 in the VCS section 30 of the sort system of its own office. In consequence, the VCS section 30 of the sort device performs processing of defining the address information based on the coding data.

Moreover, in a case where the above judgment judges that the database of the district of its own office is not new (step S37, NO), the data management device 31 judges that the coding data is processed by the VCS of the delivery office. In this case, the coding data is transferred to the sort device of the delivery office, and processed by the VCS of the delivery office (step S38).

It is to be noted that it is judged whether or not to transfer the coding data to the delivery office, based on various judgment criteria set in accordance with the operating configuration. For example, in the judgments of the steps S35 to S37, an order (priority) may be changed.

Moreover, conditions other than the installation situation of the offline OCR of the delivery office, the operating situation of the offline OCR of the delivery office and the update date of the database of the address information with respect to the district of its own office may beforehand be set as the judgment criteria for judging whether or not to transfer the coding data to the delivery office. For example, the number of cases where the recognition result obtained by the offline OCR matches the input result of the information input device is totaled for each district in advance, and the coding data may preferentially be transferred to the delivery office of the district having the largest number of the matching cases.

A reason for this is as follows.

It is judged whether or not the recognition result obtained by the offline OCR matches the address information registered in the address information database section 23 to judge whether or not the result is correct. That is, the number of the cases where the recognition result obtained by the online OCR matches the input result obtained by the information input device is the number of the processing steps of the paper sheets including the described address information which is not registered in the address information database section 23. Therefore, the database of the district having a large number of the cases where the recognition result obtained by the online OCR matches the input result obtained by the information input device can be presumed as a database having a large number of inadequacies.

In a case where it is assumed that the latest address information is registered as the database of the corresponding district in the address information database section of the sort device of the delivery office, there is high possibility that the coding data of the district having a large number of cases where the recognition result obtained by the online OCR matches the input result obtained by the information input device is efficiently processed by the delivery office. That is, the coding data of the district having a large number of cases where the recognition result obtained by the online OCR matches the input result obtained by the information input device is processed by the delivery office, whereby a processing efficiency of the whole sort system can be improved.

According to the above processing, it is judged based on the operating situation or the like of the offline OCR of the delivery office whether or not to transfer, to the sort device of the delivery office, the coding data including the images of the paper sheets from which any address information cannot completely be recognized by the offline OCR of the sort device of its own office, and the coding data is selectively transferred to the delivery office or processed by the VCS of its own office. In consequence, a resource of the offline OCR in the whole sort system can efficiently be distributed, and the efficient processing of the paper sheets can be realized in the whole sort system.

Next, the processing performed by the VCS section 30 according to the first embodiment will be described.

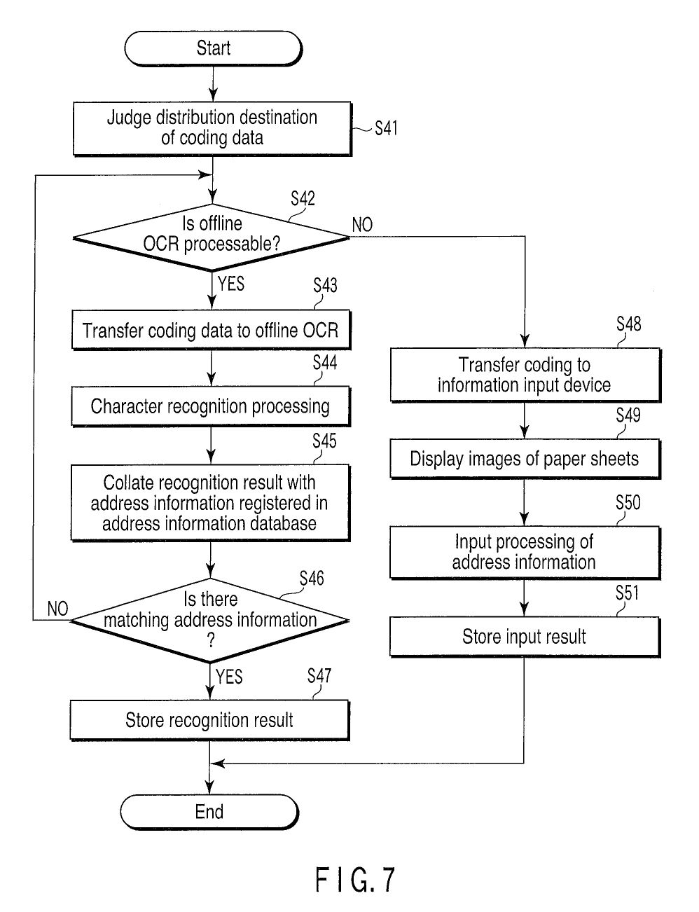

FIG. 7 is a flow chart showing a processing example in the VCS section 30 according to the first embodiment.

It is to be noted that here, the processing of the coding data judged, by the data management device 31, to be processed by the VCS section 30 of its own office will be described.

The data management device 31 performs processing of determining a distribution destination of the coding data (step S41). Examples of the distribution destination of the coding data include the information input device 33 and the offline OCR 35. Here, the coding data is preferentially distributed to the offline OCR 35.

That is, the data management device 31 judges whether or not the coding data to be distributed can be processed by the offline OCR 35 (step S42). In this judgment, for example, it is judged that the coding data processed by the offline OCR 35 cannot be processed by the offline OCR 35. Moreover, even in a case where the offline OCR 35 is waiting for the processing, it may be judged that the data cannot be processed by the offline OCR 35.

In a case where the above judgment that the data can be processed by the offline OCR 35 (step S42, YES), the data management device 31 supplies the coding data to the offline OCR 35 (step S43). The offline OCR 35 to which the coding data has been supplied performs the recognition processing (the character recognition processing) of the address information based on the images of the paper sheets included in the coding data (step S44). When the recognition result is obtained, the offline OCR 35 performs processing of collating the recognition result with address information registered in the address information database section 23 (step S45).

In a case where it is judged that as this collation result, the address information matching the recognition result obtained by the offline OCR is registered in the address information database section 23 (step S46, YES), the offline OCR 35 notifies that the recognition result seems to be definite address information (can be recognized as the address information), and supplies the address information as the recognition result to the data management device 31. In this case, the data management device 31 associates the address information as the recognition result obtained by the offline OCR 35 with the ID information (the mail ID) to store the information (step S47). This address information is output in response to a request from the identifying section 21 of the sort device main body 10 by use of the ID information as a key.

It is to be noted that the address information associated with the ID information, as the recognition result obtained by the offline OCR 35, may be transferred to the sort system of the delivery office specified by the information indicating the district in the address information.

Moreover, in a case where the above judgment judges that the address information matching the recognition result obtained by the offline OCR 35 is not registered in the address information database section 23 (step S46, NO), the offline OCR 35 notifies the data management device 31 that the address information cannot be recognized, and also transmits the recognition result. In this case, the data management device 31 judges that the coding data cannot be processed by the offline OCR 35 (step S42, NO). It is to be noted that the recognition result information in the coding data may be updated into the recognition result obtained by the offline OCR 35.

In a case where it is judged that the coding data cannot be processed by the offline OCR 35, the data management device 31 performs processing of distributing the coding data to each information input device 33 (step S48). That is, in a case where it is judged that the coding data cannot be processed by the offline OCR 35, the data management device 31 selectively distributes the coding data in accordance with a processing situation of each information input device 33 in the VCS section 30.

For example, in a state in which the video coding processing can be performed, each information input device 33 requires the coding data from the data management device 31. In response to such a request, the data management device 31 successively transfers the coding data in a case where it is judged that the data cannot be processed by the offline OCR 35. In consequence, each information input device 33 receives the coding data from the data management device 31.

The information input device 33 which has received the coding data from the data management device 31 displays, in a display device (not shown), the images of the paper sheets, the recognition result information and the like (step S49), and the information input device accepts input of the information from an input device (not shown) (step S50). In this state, an operator of the information input device 33 inputs the address information of the paper sheets into the input device while referring to the images of the paper sheets displayed in the display device.

When the operator completes the input operation of the address information in the information input device 33, the information input device 33 associates the address information input by the operator with the ID information to transfer the information to the data management device 31. In the data management device 31 which has received the address information input by the operator from the information input device 33, the address information (the address information as the input result) received from the information input device 33 is associated with the ID information and stored (step S51).

As described above, the address information as the input result stored in the data management device 31 is appropriately supplied to the identifying section 21. It is to be noted that the address information as the input result associated with the ID information may be transferred to the sort device of the delivery office specified by the information indicating the district in the address information.

It is to be noted that the data management device 31 may judge whether or not the recognition result obtained by the online OCR 22 or the offline OCR 35 matches the address information input by the information input device 33 to total the number of the matching cases. The number of the cases where the recognition result obtained by the online OCR 22 or the offline OCR 35 matches the address information input by the information input device 33 in this manner is usable in judging a quality level of the address information database section 23 of the sort device. Therefore, as described above, the number of the cases where the recognition result obtained by the online OCR 22 or the offline OCR 35 matches the address information input by the information input device 33 may be used as a judgment criterion for judging whether or not to transfer the coding data to the delivery office.

Next, a second embodiment will be described.

The second embodiment is applied to a sort device 1 and a sort system having a constitution shown in FIGS. 1 and 2. First, a flow of processing as the second embodiment applied to the sort device 1 and the sort system will schematically be described.

In the second embodiment, paper sheets are processed in the sort systems installed in a plurality of bases (offices). Here, a case where a sort device 1A of a central office performs processing of sorting the paper sheets for each area in charge will be described. In such a case, the sort device 1A of the central office sorts the paper sheets for each delivery office (each area in the district) based on address information of the paper sheets. Moreover, in the second embodiment, as shown in FIG. 1, it is assumed that there are a delivery office where the sort device is installed and a delivery office where any sort device is not installed. For example, in the constitution example shown in FIG. 1, delivery offices A, C and D are provided with sort devices 1B, 1C and 1D, respectively. The delivery office B is not provided with any sort device. In the delivery office in which the sort device is installed, the sort device can sort the paper sheets in a delivery order in the area. However, in the delivery office in which any sort device is not installed, the paper sheets cannot be sorted in the delivery order in the area.

Moreover, in the second embodiment, it is assumed that each delivery office distributes the paper sheets in each area. Therefore, in the sort system according to the second embodiment, it is assumed that the paper sheets are finally sorted in the delivery order for each area. That is, in the delivery office in which the sort device is installed, the sort device of the office can sort the paper sheets in the delivery order. Therefore, in the sort device of the central office, the paper sheets addressed to the delivery office in which the sort device is installed may be sorted for each area.

On the other hand, in the delivery office in which any sort device is not installed, the sort device in the office cannot sort the paper sheets in the delivery order. Therefore, in the sort device of the central office, the paper sheets addressed to the delivery office in which any sort device is not installed are sorted in the delivery order by the sort device of the central office. However, even in the delivery office in which the sort device is installed, it might be efficient to sort the paper sheets in the delivery order by the central office, depending on a processing capability of the sort device of the delivery office or the number of processing steps. Therefore, the delivery office (the area) to which the paper sheets to be sorted in the delivery order by the central office are addressed is determined in consideration of a processing efficiency of the whole sort system or the like.

As described above, the sort device of the central office sorts the paper sheets for each area, and further sorts, in the delivery order, the paper sheets to be sorted in the delivery order (e.g., the paper sheets addressed to the delivery office in which any sort device is not installed). Moreover, to realize the above-mentioned operating configuration, the sort device of the central office needs to identify the whole address information of at least the paper sheets to be sorted in the delivery order. However, in the second embodiment, as an operation rule, in principle, the address information of the paper sheets is defined in the sort device of the central office.

Next, processing in a sort device main body 10 according to the second embodiment will be described.

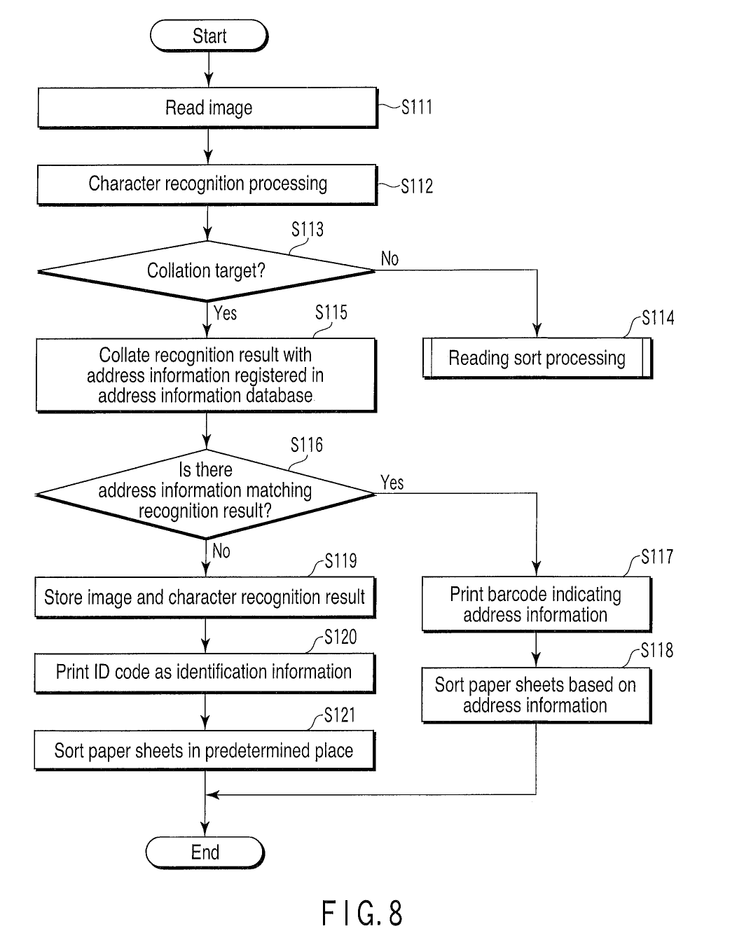

FIG. 8 is a flow chart showing a processing example in the sort device main body 10 of the sort device 1A according to the second embodiment.

First, an operator of the central office sets the paper sheets to a supply section 13 of the sort device main body 10, and instructs starting of sort processing via an operating section (not shown). Then, a control section 11 of the sort device main body 10 takes out the paper sheets set to the supply section 13 one by one to convey the sheet along a conveyance path 14a. Then, a reading section 15 reads the image on the paper sheet conveyed along the conveyance path 14a (step S111). This reading section 15 sends the read image on the paper sheet to an identifying section 21. In the control section 11, the identifying section 21 performs processing of identifying the address information of the image of the paper sheet supplied from the reading section 15. In the identifying section 21, a character recognizing section 22 performs recognition processing (character recognition processing) of address information based on the image of the paper sheets read by the reading section 15 (step S112). It is to be noted that with regard to the paper sheets on which barcodes indicating the address information are printed, the address information is determined based on the barcode read by a barcode reading section 16.

When the recognition result of characters is obtained by the character recognizing section 22, the identifying section 21 judges whether or not to collate (read) the recognition result with the address information registered in an address information database section 23 (or an address information database 3) (step S113). For example, in a case where the address information corresponding to ID information (an ID code) is registered in a data management device 31 (i.e., the information is subjected to coding processing by an information input section) or the barcode indicating an address is printed on the paper sheet, the identifying section 21 judges that reading with the address information is unnecessary. As a recognition result, when information indicating the district indicates a district other than the corresponding district, the result does not have to be collated with the address information database section 23.

In a case where the above judgment judges that the recognition result does not have to be collated with the address information registered in the address information database section 23 (step S113, NO), the control section 11 judges the address information of the paper sheet based on the recognition processing result obtained by the character recognizing section 22 or the barcode, to sort the paper sheets (step S114).

Moreover, in a case where the above judgment judges that the recognition result of characters obtained by the character recognizing section 22 needs to be collated with the address information registered in the address information database section 23 (step S113, YES), the identifying section 21 performs the collation processing of the recognition result obtained by the character recognizing section 22 with the address information registered in the address information database section 23 (step S115). This collation processing judges whether or not the recognition result obtained by the character recognizing section 22 matches any address information registered in the address information database section 23 to judge whether or not the recognition result obtained by the character recognizing section 22 is correct. Therefore, as a result of the collation processing, the identifying section 21 judges whether or not the address information matching the recognition result obtained by the character recognizing section 22 is registered in the address information database section 23 (step S116).

In a case where the above judgment judges that the address information matching the recognition result obtained by the character recognizing section 22 is registered in the address information database section 23 (step S116, YES), the control section 11 defines, as the address information of the paper sheets, the address information which is the recognition result judged by the identifying section 21. When the address information of the paper sheets is defined, the control section 11 converts the address information into the barcode (an address code) to be printed on the paper sheet. When the address information is converted into the barcode, the control section 11 allows an address code printing section 18 to print the barcode on the corresponding paper sheet (step S117). In this case, the paper sheets on which the barcodes indicating the address information as the recognition result obtained by the character recognizing section 22 are printed are sorted by a sort section 19 into sort pockets of an integrating section 20 based on the address information (step S118).

Moreover, in a case where the above judgment judges that the address information matching the recognition result obtained by the character recognizing section 22 is not registered in the address information database section 23 (step S116, NO), the control section 11 issues ID information on the paper sheets. When the ID information on the paper sheets is issued, the control section 11 stores, in the data management device 31, the image of the paper sheets read by the reading section 15 and the recognition result of the paper sheet obtained by the character recognizing section 22, in association with the ID information (step S119).

Moreover, when the address information of the paper sheets cannot be recognized, the control section 11 converts the issued ID information into a barcode (an ID code), and an ID code printing section 17 prints the ID codes indicating the ID information on the paper sheets (step S120). The ID codes are printed on the paper sheets in which any address information cannot be recognized in this manner, and then the paper sheets are sorted into an integration storage for VCS (hereinafter referred to as the VCS integration storage), as the paper sheets from which any address information cannot be recognized by the sort section 19 (step S121). In consequence, in the VCS integration storage, there are integrated the paper sheets (the paper sheets on which the ID codes are printed) from which any address information cannot be recognized by the character recognizing section (the online OCR) 22.

Next, processing in a VCS section 30 according to the second embodiment will be described.

In the above-mentioned processing of the sort device main body 10 according to the second embodiment, with regard to the paper sheets from which any address information cannot be recognized, the operator performs processing of inputting the address information via each information input device 33 in the VCS section 30.

That is, the data management device 31 manages the images of the paper sheets supplied from the sort device main body 10 and the recognition result obtained by the online OCR 22 as coding data associated with the ID information of the paper sheets. Such coding data is distributed to each information input device 33. In the information input device 33, the images of the paper sheets, the recognition result obtained by the character recognizing section (the online OCR) 22 and the like included in the coding data are displayed. The operator inputs the address information.

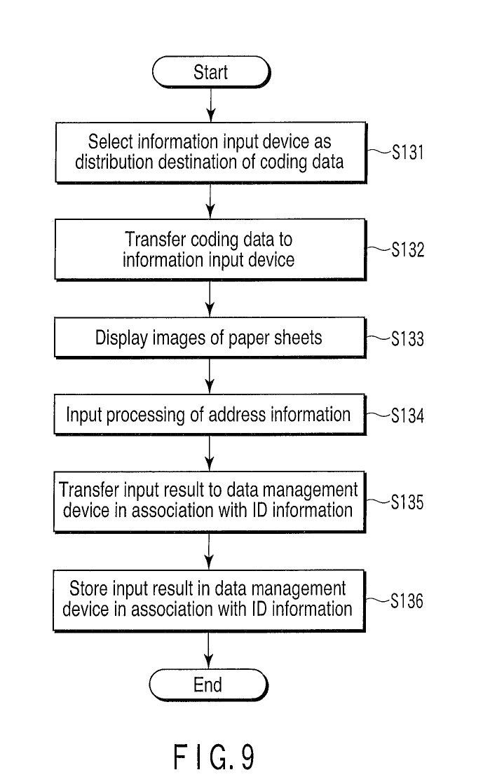

FIG. 9 is a flow chart showing a processing example in the VCS section 30 according to the second embodiment.

That is, the data management device 31 judges the information input device 33 or an offline OCR 35 to which the above coding data is to be distributed (step S131). For example, in a state in which video coding processing can be performed, each information input device 33 requires the coding data from the data management device 31. Based on such a request from each information input device 33, the data management device 31 determines a distribution destination of the stored coding data. It is to be noted that in this second embodiment, to simplify description, a case where the address information of the paper sheets is subjected to the coding processing by the information input device 33 is assumed and described.

When the information input device 33 is determined as the distribution destination of the coding data as described above, the data management device 31 successively transfers the coding data to the determined distribution destination (step S132).

On the other hand, each information input device 33 performs processing of receiving the coding data transferred from the data management device 31, and allowing the operator to input the address information with respect to the coding data (steps S133, S134).

That is, in the information input device 33 which has received the coding data from the data management device 31, the images of the paper sheets, the character recognition result obtained by the character recognizing section 22 and the like are displayed in a display device (not shown) (step S133), and the input of the information via an input device (not shown) is accepted (step S134). In this state, the operator of each information input device 33 inputs the address information of the paper sheets into the input device while referring to the images of the paper sheets, the character recognition result obtained by the character recognizing section 22 and the like displayed in the display device. When the operator completes the input operation of the address information in the information input device 33, the information input device 33 associates the address information (input information) input by the operator with the ID information to transfer the information to the data management device 31 (step S135).

On the other hand, in the data management device 31 which has received the address information input by the operator via the information input device 33, the input information received from the information input device 33 is associated with the ID information and stored (step S136). The input information stored in this data management device 31 is appropriately output to the sort device main body 10 in response to a transfer request from the identifying section 21 by use of the ID information as a key. In consequence, the identifying section 21 can read an ID code from the paper sheet on which the ID code is printed, to acquire the address information corresponding to the ID code. It is to be noted that the address information associated with the ID information is transferred to another sort device in the sort system.

Next, processing of the paper sheets on which the ID codes are printed according to the second embodiment will be described.

In the above-mentioned processing of the sort device main body 10 according to the second embodiment, the ID information is applied to the paper sheets from which the address information cannot be identified by the character recognizing section (the online OCR) 22, and the paper sheets provided with the ID information are sorted into an integration storage for VCS (hereinafter referred to as the VCS integration storage). Furthermore, in the above-mentioned processing example of the VCS section 30, the operator is allowed to input the address information of the paper sheets provided with the ID information via the information input device 33, and the input information as the address information input by the operator is associated with the ID information and stored in the data management device 31.

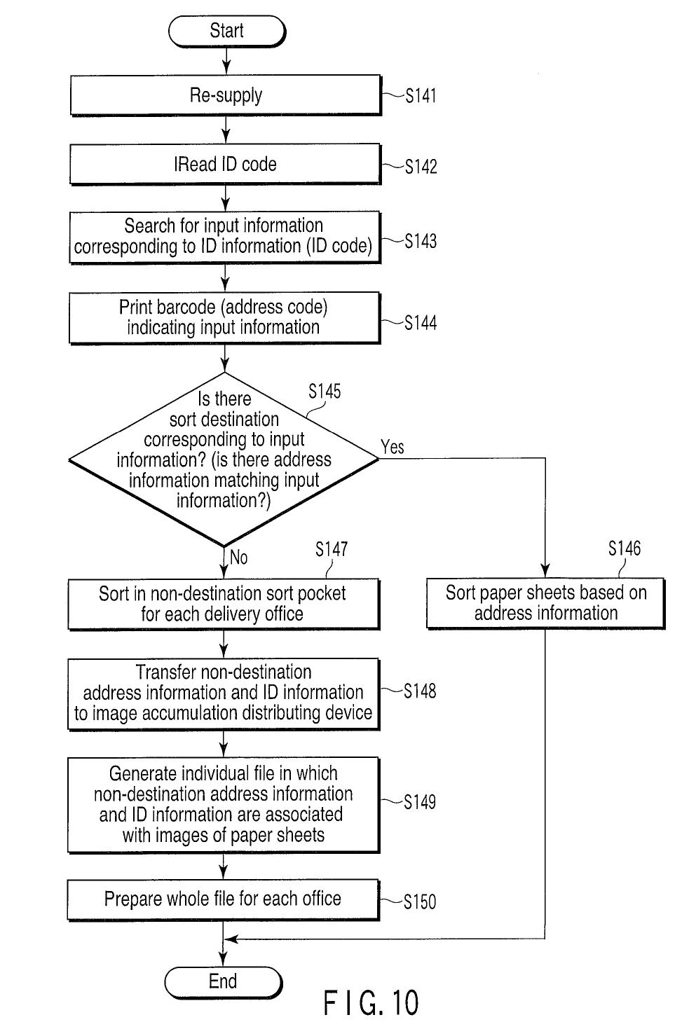

FIG. 10 is a flow chart showing a processing example of the paper sheets having ID codes printed thereon according to the second embodiment.

In a state in which the input information is stored in the data management device 31, the operator of the sort device main body 10 sets the paper sheets accumulated in the VCS integration storage to the supply section 13 again, and instructs starting of sort processing via an operating section (not shown) (step S141). Then, the control section 11 of the sort device main body 10 takes out the paper sheets set to the supply section 13 one by one to convey the sheet along the conveyance path 14a. In this case, in the sort device main body 10, the barcode reading section 16 reads the ID code printed on the paper sheet (step S142). Barcode information read by the barcode reading section 16 is supplied to the control section 11. The control section 11 identifies the ID information based on the barcode read from the paper sheet. On identifying the ID information, the control section 11 performs processing of searching for the input information corresponding to the ID information from the input information stored in the data management device 31 (step S143).

On acquiring the input information corresponding to the ID information read from the paper sheet, the control section 11 converts the input information into the barcode to print the converted barcode as an address code on the paper sheet (step S144).

Moreover, on acquiring the input information corresponding to the ID information read from the paper sheet, the control section 11 performs processing of determining a sort pocket as a sort destination corresponding to the input information (step S145). Here, each address information registered in the address information database section 23 is beforehand associated with each sort pocket of the integrating section 20. In other words, it can be judged that the address information as the input information in which the sort pocket as the sort destination is present is the address information registered in the address information database section 23, and it can be judged that the address information as the input information in which the sort pocket (a sort pocket other than a non-destination integration storage) as the sort destination is not present is the address information which is not registered in the address information database section 23.

When the above judgment specifies the sort pocket as the sort destination corresponding to the input information, the control section 11 sorts the paper sheets into the sort pocket as the sort destination corresponding to the address information as the input information (step S146). In consequence, the paper sheets in which the sort destination corresponding to the address information as the input information is set (i.e., the paper sheets in which the input information is registered as the address information in the address information database section 23) are integrated in the sort pocket corresponding to the address information as the input information.

In a case where the above judgment judges that the sort pocket as the sort destination corresponding to the input information is not present, that is, the address information corresponding to the input information is not registered in the address information database section 23, the control section 11 sorts the paper sheets into a predetermined integration storage (a non-destination integration storage) for sorting the paper sheets having unclear sort destination (step S147). In consequence, the paper sheets in which the sort destinations corresponding to the address information as the input information are not set (i.e., the paper sheets in which the input information is not registered as the address information in the address information database) are integrated in the non-destination integration storage.

Moreover, in a case where the above judgment judges that the sort pocket as the sort destination corresponding to the input information is not present, the control section 11 supplies, to the data management device 31, the ID information corresponding to the ID code printed on the paper sheet and the address information (non-destination input information) corresponding to the address code printed on the paper sheet (step S148).

The data management device 31 which has received the ID information and the non-destination address information from the control section 11 prepares an individual file (a file for one paper sheet) including the non-destination address information, the ID information and the image of the paper sheet (step S149). In this individual file, the image of the paper sheet is associated with the address information as the input information. Therefore, according to the individual file, the non-destination input information (the address information) can be confirmed in association with the image of the paper sheet.

Moreover, in the individual file, the address information as the input information is computerized. Therefore, in the address information database section 23, the non-destination address information (i.e., unregistered address information) does not have to be manually input (registered), and the computerized address information of the individual file can easily be registered. According to the above-mentioned processing, the processing of the address information for one case is completed.

Furthermore, the data management device 31 also has a function of integrating the individual files for each office. The data management device 31 integrates the individual files of each office as the whole file of each office. That is, the data management device 31 selects each individual file for each delivery office in charge based on information indicating the area in the address information. On selecting the individual files for each delivery office, the data management device 31 prepares the whole file of the delivery office from the selected individual files (step S150).

In consequence, the sorted non-destination address information in the address information including the area information of the delivery office is stored in the whole file. As described above, the non-destination address information is the address information which is not registered in the address information database section 23. In consequence, a clerk can confirm a list of the address information which is not registered in the address information database section 23 by use of the whole file.

The whole file is transferred to the delivery office, stored as data for the delivery office in a storage medium, or printed and output as the data for the delivery office. For example, the whole file of the delivery office in which the sort device is installed is transferred to the sort device of the delivery office via the center server 2, and the whole file of the delivery office in which any sort device is not installed may be stored in the storage medium.

It is to be noted that, for example, with regard to the area (the delivery office) in which the sort device is set, every time the individual file is prepared, the individual file may be transferred to the sort device of the area. In this case, the sort device of the area may prepare the whole file of the area, or store the information stored in each individual file in a data table or the like. Moreover, even in the area in which any sort device is not installed, in a case where a data processing device such as a computer that can perform data communication with the sort device of the central office is installed in the area (the delivery office), the sort device of the central office may transfer the individual file or the whole file to the data processing device of the area.

As described above, in the present sort device, in a case where the defined address information is not registered in the address information database section 23, the file (the individual file) including the address information is prepared. Furthermore, the sort device prepares the whole file in which the above-mentioned individual files are integrated for each area (the delivery office) included in the address information.

In consequence, the clerk or a manager can easily confirm a deficiency of the address information database section 23 or evaluate a processing situation of the paper sheets with reference to the above-mentioned individual files or the whole file. Moreover, the clerk or the manager can easily confirm the deficiency of the address information registered in the address information database section 23 for each area (the delivery office) with reference to the whole file. As a result, the address information database section 23 can efficiently be updated in order to improve a processing efficiency of the whole sort system.

Moreover, in the individual file or the whole file, the address information as a candidate to be registered in the address information database is obtained as electronic data (the address code). Therefore, an operation of registering the address information formed into the individual file or the whole file in the address information database section 23 is facilitated. In particular, in a case where new address information is registered in the address information database for sorting the paper sheets in the delivery order, when the operator designates a portion to be registered based on the delivery order, new address information can easily be registered in the address information database section 23.

Furthermore, the information input by the information input device 33 of the VCS section 30 is the address information input by the operator. In the present sort device, the information input by the information input device 33 is defined as the address information. In the information input device 33, wrong address information might be input owing to erroneous input by the operator. Therefore, the address information simply stored in the individual file or the whole file is not necessarily the address information to be registered in the address information database. Therefore, the clerk needs to confirm whether or not the address information is the address information to be registered in the address information database.

In such judgment performed by the clerk, in a case where it is judged that the address information as the input information is not registered in the address information database, it is difficult to correctly judge whether or not the address information is the address information to be registered in the address information database. Specifically, it is preferable that the clerk collates the address information as the input information in which it is judged that the information is not registered in the address information database with the surface itself of the paper sheet on which the address information is described, to confirm whether or not to register the address information in the address information database.

In the individual file or the whole file prepared by the sort device according to the second embodiment as described above, the image of the surface of the paper sheet on which the address information is described is stored together with the address information as the input information in which it is judged that the information is not registered in the address information database. Therefore, the clerk can confirm the address information together with the image of the paper sheet, and it can easily and correctly be judged whether or not the address information is the address information to be registered in the address information database.

Next, a third embodiment will be described.

The third embodiment is applied to a sort device 1 and a sort system having a constitution shown in FIGS. 1 and 2. In the third embodiment, a case where a sort device 1A of a central office provided in each district performs processing of sorting paper sheets for each area in charge will be described. That is, in the sort system according to the third embodiment, the sort device 1A of the central office (an acceptance office) sorts the paper sheets for each delivery office (each area in the corresponding district) based on address information of the paper sheets.

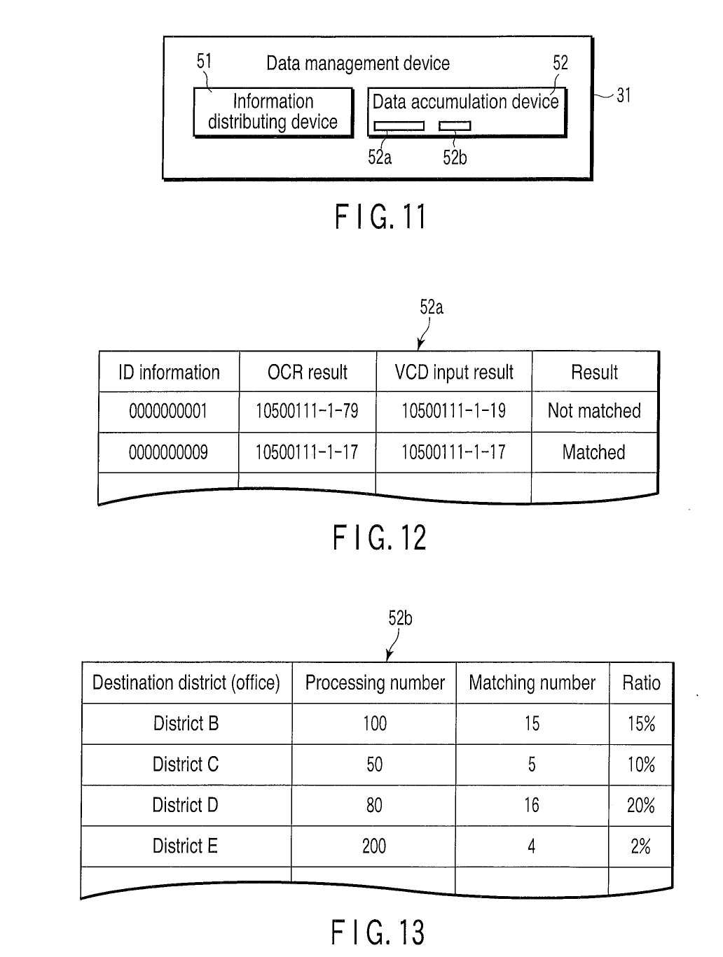

FIG. 11 is a diagram showing a constitution example of a data management device 31 of a sort device according to the third embodiment. As shown in FIG. 11, in the sort device according to the third embodiment, the data management device 31 shown in FIG. 2 has an information distribution device 51 and a data accumulation device 52.

The information distribution device 51 functions as an interface for transferring coding data from a sort device main body 10 to each information input device 33 or an offline OCR 35. It is to be noted that in the third embodiment described hereinafter, a case where each information input device 33 performs coding processing in a VCS section 30 is assumed and described.

That is, in the information distribution device 51, there is accumulated information (information for video coding) such as images of the paper sheets from which a identifying section 21 judges that any address information cannot be recognized. For example, in the information distribution device 51, in association with ID information (an ID code) applied to the paper sheets, the images of the paper sheets and a recognition result of characters as the address information obtained by an online OCR (a character recognizing section) 22 are accumulated. Moreover, the information distribution device 51 distributes, to each information input device 33, information for video coding (video coding information) associated with the ID information and including the images of the paper sheets, the recognition result of the characters and the like for each piece of paper sheet.

As described above, the information input devices 33 (33a, 33b, . . . ) are devices via which the operator inputs the address information based on information for video coding such as the images of the paper sheets distributed from the information distribution device 51, respectively. Moreover, in one sort device, the information distribution device 51 is connected to a plurality of information input devices 33. Each information input device 33 notifies a processing situation or the like to the information distribution device 51, and an input operation of the address information is performed based on the information for video coding distributed from the information distribution device 51 in accordance with the notified processing situation. Furthermore, the information input by a clerk via each information input device 33 is accumulated in the data accumulation device 52.

Moreover, as described above, each information input device 33 is constituted of, for example, a control section, a storage section, a display section, an operating section and the like. In each information input device 33, in a state in which the images of the paper sheets in the information for video coding received from the information distribution device 51 are displayed in the display section and the images of the paper sheets are displayed in the display section, the input of the address information or the like by the operator is accepted. Furthermore, in each information input device 33, input information input as the address information by the operator is transferred to the data accumulation device 52, as processed data (coded information) associated with the ID codes of the paper sheets.

The data accumulation device 52 is a device in which the information input by the information input device 33 or the like is accumulated. Moreover, in the data accumulation device 52, the accumulated data is transferred to the sort device main body 10.

The data accumulation device 52 has an input information database 52a and a total data table 52b. In the input information database 52a, the information input by the information input device 33 is associated with the ID codes of the paper sheets and accumulated. The information stored in this input information database 52a will be described later in detail. The total data table 52b is a data table for totaling the number of cases where a recognition result obtained by the online OCR (the character recognizing section) 22 matches the information input by the information input device 33. The information stored in the total data table 52b will be described later in detail.

Moreover, the sort device main body 10 connected to the data accumulation device 52 having the above constitution has a function of sorting the paper sheets based on the processed data accumulated in the input information database 52a. For example, with regard to the paper sheets in which the address information is coded by the information input device 33, the sort device main body 10 reads the ID code applied to the paper sheet, and searches for the address information (the input information) of the paper sheet corresponding to the ID code from the input information database to sort the paper sheets based on the searched address information.

Next, the input information database 52a will be described.

The input information database 52a is a database in which the information input by each information input device 33 as the address information of the paper sheets is accumulated. In the input information database 52a, the recognition result of the address information obtained by the online OCR 22 with respect to the paper sheets is associated with the address information input by each information input device 33, and stored.

FIG. 12 is a diagram showing a constitution example of the input information database 52a.

In the constitution example shown in FIG. 12, in the input information database 52a, ID information, a processing result of OCR (the OCR result), a processing result of a VCD (a VCD input result), a comparison result (a result) and the like are stored with respect to the paper sheets as processing targets of the information input device 33. The ID information is information indicating the ID code applied to the paper sheet by the sort device main body 10. The OCR result is information as a result of character recognition processing performed by the online OCR (the character recognizing section) 22. The VCD input result is information input by the information input device 33. The comparison result is information indicating whether or not the OCR result matches the VCD input result.

In the example shown in FIG. 12, with regard to the paper sheets in which the ID information is “0000000001”, the recognition result of the address information obtained by the online OCR 22 is “10500111-1-79”, the input result of the address information by the information input device 33 is “10500111-1-19”, and the comparison result is “not matched”. Moreover, in the example shown in FIG. 12, with regard to the paper sheets in which the ID information is “0000000009”, the recognition result of the address information obtained by the online OCR 22 is “10500111-1-17”, the input result of the address information by the information input device 33 is “10500111-1-17”, and the comparison result is “matched”.

That is, in the example shown in FIG. 12, with regard to the paper sheets in which the ID information is “0000000001”, the result of the character recognition processing performed by the online OCR 22 and the information input by the information input device 33 are “not matched”. Therefore, it is predicted that the character recognition processing performed by the online OCR 22 with respect to the paper sheets in which the ID information is “0000000001” is wrong. In other words, when the information input by the information input device 33 is correct, the character recognition processing performed by the online OCR 22 is wrong.

Moreover, in the example shown in FIG. 12, with regard to the paper sheets in which the ID information is “0000000009”, the result of the character recognition processing performed by the online OCR 22 and the information input by the information input device 33 are “matched”. Therefore, it is predicted that the character recognition processing performed by the online OCR 22 with respect to the paper sheets in which the ID information is “0000000009” is correct. In other words, when the information input by the information input device 33 is correct, the character recognition processing performed by the online OCR 22 is correct.

When the recognition result obtained by the character recognizing section 22 matches the input result obtained by the information input device 33, it is indicated that the address information described on the paper sheets is address information which is not registered in an address information database section 23. However, the address information described on the paper sheets is not necessarily completely correct.

However, in a case where a plurality of similar paper sheets are present, it is predicted that the address information described on the paper sheets is correct. If the address information described on the paper sheets is correct, the address information registered in the address information database section 23 is not correct, that is, does not correspond to any address information.

Next, the total data table 52b will be described.

In the total data table 52b, there is stored total data indicating the number of cases where the recognition result obtained by the online OCR (the character recognizing section) 22 matches the information input by each information input device 33 as the address information. Moreover, in the total data table 52b, there is accumulated data obtained by totaling, for each delivery office, the number of the cases where the recognition result obtained by the online OCR (the character recognizing section) 22 matches the information input by the information input device 33 as the address information.

FIG. 13 is a diagram showing a constitution example of the total data table 52b.

In the constitution example shown in FIG. 13, in the total data table 52b, a district of a destination, a processing number, a matching number, a ratio and the like are stored.

As the district of the destination, information indicating each district as a sort destination in dispatch sort processing (processing of sorting the paper sheets for each district) is stored. The district of the destination is identified in accordance with information of first data (a predetermined number of upper digits of coded address information (e.g., upper three digits)) in the address information. As the processing number, information indicating the number of cases processed by the information input device 33 is stored for each district. As the matching number, information indicating the number of cases where the result of the character recognition processing performed by the online OCR 22 matches the result input by the information input device 33 is stored for each district. As the ratio, information indicating a ratio of the matching number with respect to the processing number is stored for each district.

In the example shown in FIG. 13, with regard to the paper sheets addressed to district B, it is indicated that 100 cases are processed by the information input device 33, the cases include 15 cases where the character recognition result obtained by the character recognition device matches the input result obtained by the information input device, and the ratio of the matching number with respect to the processing number is 15%. Moreover, with regard to the paper sheets addressed to district C, it is indicated that 50 cases are processed by the information input device 33, the cases include five cases where the character recognition result obtained by the online OCR (the character recognizing section) 22 matches the input result obtained by the information input device 33, and the ratio of the matching number with respect to the processing number is 10%. Furthermore, with regard to the paper sheets addressed to district D, it is indicated that 80 cases are processed by the information input device 33, the cases include 16 cases where the character recognition result obtained by the online OCR (the character recognizing section) 22 matches the input result obtained by the information input device 33, and the ratio of the matching number with respect to the processing number is 20%. In addition, with regard to the paper sheets addressed to district E, it is indicated that 200 cases are processed by the information input device 33, the cases include four cases where the character recognition result obtained by the online OCR (the character recognizing section) 22 matches the input result obtained by the information input device 33, and the ratio of the matching number with respect to the processing number is 2%.

Next, a flow of processing of the paper sheets in the whole sort system according to the third embodiment will schematically be described.

In the present paper sheets processing system, the paper sheets are processed in the sort systems installed in a plurality of bases (offices). Here, in the base which collects the paper sheets, dispatch sort processing is performed to sort the paper sheets for each base in charge. The base which sorts such collected paper sheets for each base is referred to as an acceptance office. In each base that has received the paper sheets subjected to the dispatch sort processing in the above-mentioned acceptance office, delivery sort processing (routing assembly processing) is performed to sort the paper sheets in a predetermined order such as a delivery order. The base which sorts, in the predetermined order, the paper sheets subjected to dispatch sorting is referred to as the delivery office.

As described above, in the paper sheets processing system, the paper sheets subjected to the dispatch sort processing by the acceptance office are sorted in the predetermined order by each delivery office. Such a paper sheets processing system is operated according to a predetermined operation rule in order to smoothly and efficiently perform the processing of the paper sheets in the whole system. Here, in the dispatch sort processing of the acceptance office, all the address information is entirely defined.

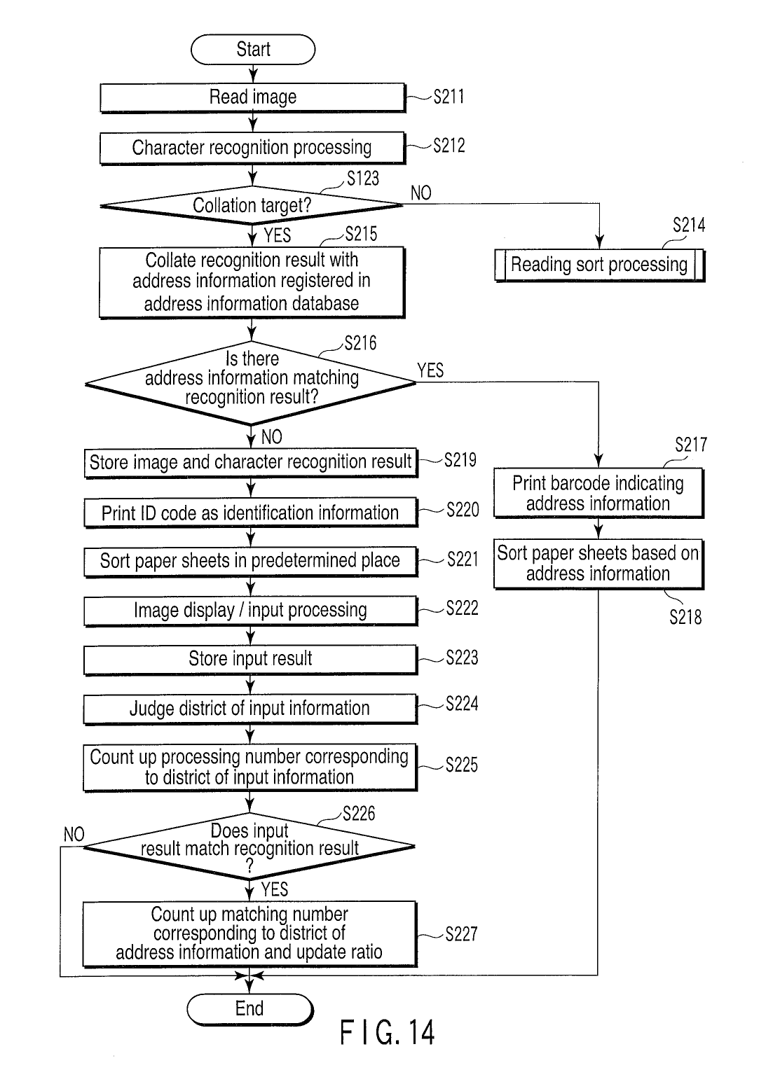

FIG. 14 is a flow chart showing a processing procedure with respect to the paper sheets in the dispatch sort processing of each sort device 1A according to the third embodiment.

First, a clerk of the acceptance office sets the collected paper sheets to a supply section 13 of the sort device main body 10, and instructs starting of the dispatch sort processing via an operating section (not shown). Then, a control section 11 of the sort device main body 10 takes out the paper sheets set to the supply section 13 one by one to convey the sheet along a conveyance path 14a. Then, a reading section 15 reads an image on the paper sheet conveyed along the conveyance path 14a (step S211). This reading section 15 sends the read image on the paper sheet to the identifying section 21. In the identifying section 21, the online OCR 22 performs recognition processing (character recognition processing) of the address information based on the image of the paper sheet supplied from the reading section 15 (step S212). It is to be noted that with regard to the paper sheets on which barcodes indicating the address information are printed, the address information is judged based on the barcode read by a barcode reading section 16.

When the recognition result of characters is obtained by the online OCR 22, the identifying section 21 judges whether or not to collate (read) the recognition result with the address information registered in the address information database section 23 (step S213). For example, in a case where the address information corresponding to mail ID is registered in the data accumulation device 52 (i.e., the information is subjected to coding processing by the information input device) or the barcode indicating an address is printed on the paper sheet, the identifying section 21 judges that reading with the address information is unnecessary. It is to be noted that the above judgment may be performed by the control section 11.

In a case where the above judgment judges that the recognition result does not have to be collated with the address information registered in the address information database section 23 (step S213, NO), the identifying section 21 supplies, to the control section 11, the result of the recognition processing performed by the online OCR 22. It is to be noted that when the recognition result is not necessary, the identifying section 21 may not output the recognition result obtained by the character recognizing section (the online OCR) 22. Moreover, in a case where the above judgment judges that the collation of the recognition result with the address information registered in the address information database section 23 is unnecessary, the control section 11 judges the address information of the paper sheets based on the recognition processing result or the barcodes, to sort the paper sheets (step S214).

Furthermore, in a case where the above judgment judges that the collation of the character recognition result obtained by the online OCR 22 with the address information registered in the address information database section 23 is unnecessary (step S213, YES), the identifying section 21 performs collation processing of the recognition result obtained by the online OCR 22 with the address information registered in the address information database section 23 (step S215). In this collation processing, it is judged whether or not the recognition result obtained by the online OCR 22 matches any address information registered in the address information database section 23 to judge whether or not the recognition result obtained by the online OCR 22 is correct. Therefore, as a result of the collation processing, the identifying section 21 judges whether or not the address information matching the recognition result obtained by the online OCR 22 is registered in the address information database section 23 (step S216).

In a case where the above judgment judges that the address information matching the recognition result obtained by the online OCR 22 is registered in the address information database section 23 (step S216, YES), the identifying section 21 supplies, to the control section 11, information indicating that the recognition result seems to be correct together with the recognition result. In consequence, the control section 11 defines, as the address information of the paper sheets, the address information which is the recognition result supplied from the identifying section 21. When the address information of the paper sheets is defined, the control section 11 converts the address information into the barcode. When the address information is converted into the barcode, the control section 11 allows an address code printing section 18 to print the barcode on the corresponding paper sheet (step S217). In this case, the paper sheets on which the barcodes indicating the address information as the recognition result obtained by the online OCR 22 are printed are sorted by a sort section 19 based on the address information (step S218).

Moreover, in a case where the above judgment judges that the address information matching the recognition result obtained by the online OCR 22 is not registered in the address information database section 23 (step S216, NO), the identifying section 21 issues ID information on the paper sheets. When the ID information on the paper sheets is issued, the identifying section 21 stores, in the information distribution device 51, the image of the paper sheets read by the reading section 15 and the recognition result of the paper sheet obtained by the online OCR 22, in association with the ID information (step S219).

Furthermore, the identifying section 21 notifies the control section 11 that the address information of the paper sheets cannot be recognized, together with the issued ID information. When it is notified from the identifying section 21 that the address information cannot be recognized, together with the ID information, the control section 11 allows an ID code printing section 17 to print an ID code indicating the ID information on the paper sheet (step S220). The ID code is printed on the paper sheet in which any address information cannot be recognized in this manner, and then the paper sheet is sorted as the paper sheet in which any address information cannot be recognized, and integrated in a predetermined sort place (step S221).

On the other hand, the images of the paper sheets and the recognition result obtained by the online OCR 22 stored in the information distribution device 51 are managed as video coding information on the paper sheets by use of the ID codes. Such video coding information on the paper sheets is distributed from the information distribution device 51 to the information input devices 33. For example, in a state in which video coding processing can be performed, each information input device 33 requires the video coding information from the information distribution device 51. In response to such a request, the information distribution device 51 successively transfers the stored video coding information. In consequence, each information input device 33 receives the video coding information from the information distribution device 51.

The information input device 33 which has received the video coding information from the information distribution device 51 displays, in a display device (not shown), the images of the paper sheets, the character recognition result obtained by the online OCR 22 and the like, and the information input device accepts input of the information from an input device (not shown) (step S222). In this state, an operator of the information input device 33 inputs the address information of the paper sheets into the input device while referring to the images of the paper sheets displayed in the display device.

When the operator completes the input operation of the address information in the information input device 33, the information input device 33 associates the address information input by the operator and the recognition result obtained by the online OCR 22 with the ID information to transfer the information to the data accumulation device 52. In the data accumulation device 52 which has received the address information input by the operator from the information input device 33, the address information received from the information input device 33 is associated with the ID information and appropriate supplied to the identifying section 21. In consequence, the identifying section 21 can read the ID code from the paper sheet having the ID code printed thereon, to acquire the address information corresponding to the ID code. It is to be noted that the address information associated with the ID information may be transferred to another sort system such as the sort system of the district.

Moreover, in the data accumulation device 52, the address information input by the operator and received from the information input device 33 together with the recognition result obtained by the online OCR 22 is associated with the ID information and stored in the input information database 52a (step S223). It is to be noted that the data accumulation device 52 receives the ID information and the recognition result of the online OCR 22 from the information distribution device 51, and the ID information and the recognition result of the online OCR 22 may be stored in the input information database 52a. In this case, the data accumulation device 52 may add the address information input by the information input device 33 to the input information database 52a.

When the recognition result (the OCR result) of the online OCR 22 and the address information (a VCD input result) input by the information input device 33 are stored in the input information database 52a, the data accumulation device 52 judges the district of the address information as the VCD input result based on information included in the VCD input result and indicating the district (step S224). When the district of the address information as the VCD input result is judged, the data accumulation device 52 updates the processing number as total data corresponding to the district in the total data table 52b (step S225). For example, if the district of the address information as the VCD input result is district B, the processing number of the district B is counted up as much as one in the total data table 52b having the constitution shown in FIG. 13.

Moreover, when the recognition result of the online OCR 22 and the input result of the information input device 33 are stored in the input information database 52a, the data accumulation device 52 collates the recognition result of the online OCR 22 with the input result of the information input device 33 to judge whether or not both the results match each other (step S226).

In a case where as a result of this collation, it is judged that the recognition result of the online OCR 22 does not match the input result of the information input device 33 (step S226, YES), the sort device 1A ends a series of processing of the paper sheets.

Moreover, in a case where as the result of the above collation, it is judged that the recognition result of the online OCR 22 matches the input result of the information input device 33 (step S226, YES), the data accumulation device 52 updates the matching number and the ratio as the total data corresponding to the district of the address information as the VCD input result (or the OCR result) in the total data table 52b (step S227). In consequence, the sort device 1A ends a series of processing with respect to the paper sheets.

It is to be noted that the paper sheets in which the address information is input by the information input device 33 are accumulated in a predetermined place in a state in which the ID codes are printed on the paper sheets. Such paper sheets are supplied to the supply section 13 again. In the sort device main body 10, as described above, the ID code is read from the paper sheet having the ID code printed thereon, and the identifying section 21 judges the address information (the address information input by the information input device 33) corresponding to the ID code, to sort the paper sheets based on the judged address information. In consequence, the paper sheets are sorted in accordance with the address information input by the information input device 33.

As described above, in the sort device according to the third embodiment, in a case where it is judged that the character information as the recognition result of the online OCR 22 is not the address information registered in the address information database section 23, the recognition result of the online OCR 22 is compared with the input result of the information input device 33, and the number of the cases where both the results match each other is stored as the total data. In consequence, in the sort system according to the third embodiment, a situation of the address information database section 23 can easily be evaluated. As a result, the address information database section 23 can efficiently be updated in order to improve a processing efficiency of the whole system.

That is, in a case where the recognition result of the online OCR 22 does not match the input result of the information input device 33, it is supposed that the address information obtained by the character recognition processing of the online OCR 22 is wrongly recognized. Therefore, the sort device 1A handles the input result of the information input device 33 as the address information of the paper sheets.

On the other hand, in a case where the recognition result of the online OCR 22 matches the input result of the information input device 33, it is supposed that the address information obtained by the character recognition processing of the online OCR 22 has been correctly recognized. Therefore, the sort device 1A handles the input result of the information input device 33 of the address information of the paper sheets.

Moreover, in a case where the recognition result of the online OCR 22 matches the input result of the information input device 33, it is indicated that the address information described on the paper sheets is not registered in the address information database section 23. This is supposedly a case where the address information is not registered in the address information database section 23, even if the address information described on the paper sheets is correct. In a case where the address information is not registered in the address information database section 23 although the address information described on the paper sheets is correct, it can be said that the sort device 1A (the address information database section of the sort system) has a deficiency.

Furthermore, according to the third embodiment described above, the number of the cases where the recognition result of the online OCR 22 matches the input result of the information input device 33 is accumulated as the total data in the total data table 52b. That is, in the total data table 52b, the total data indicating the above-mentioned deficiency of the address information database section 23 in a numeric value is accumulated. To be precise, wrong address information (e.g., address information which does not actually exist) might be obtained as the recognition result of the online OCR 22, and the wrong address information might similarly be input by the information input device 33.

Therefore, the number of the cases where the recognition result of the online OCR 22 matches the input result of the information input device 33 might not necessarily match information indicating the number of the processed paper sheets provided with correct address information which is not registered in the address information database section 23. However, in the total data table 52b, the number of the cases where the recognition result of the online OCR 22 matches the input result of the information input device 33 is accumulated. Therefore, in the third embodiment, it can easily be judged that the correct address information which is not registered in the address information database section 23 is present. Alternatively, a processing situation of the paper sheets provided with the correct address information which is not registered in the address information database section 23 can easily be judged.

For example, in the total data table 52b, the processing number is associated and stored together with the matching number, and the ratio of the matching number to the processing number is accumulated as integrated data. Therefore, in a case where the matching number is large or the ratio is large, it can be judged that there is high possibility that the correct address information which is not registered in the address information database section 23 is present. Moreover, the processing situation in which the number of the processed paper sheets provided with such address information is large can be judged.

Moreover, in the total data table 52b, the processing number, the matching number and the ratio are stored for each district. Therefore, with reference to the total data stored in the total data table 52b, it can easily be judged that the correct address information which is not registered in the address information database section 23 is present for each district.

It is to be noted that in the third embodiment described above, the processing example in the sort device 1A has mainly been described. As an application example of this third embodiment, the data accumulated in the input information database 52a of the sort device 1A, or the data totaled in the total data table 52b may be used in updating the address information database section 23 of another sort device 1B, . . . .

Examples of the above application example of the third embodiment include the following configuration.

A system provided with a sort system for each district is assumed. In such a system, a certain sort system (referred to as the first sort system) integrates data accumulated in the input information database 52a and indicating that an OCR result matches a VCD input result into a file for each district. The first sort system distributes the data filed for each district to another sort system (referred to as the second sort system). In the second sort system which has received such a file, update processing of the address information database section 23 of the second sort system is performed based on the address information included in the file. According to such an operating configuration, the address information database section 23 of each sort system installed in each district can efficiently be updated.

The above-mentioned first, second and third embodiments may appropriately be combined and implemented.

That is, the first and second embodiments are combined and implemented, whereby efficient update of the address information database can be promoted while efficiently operating the offline OCR. For example, the processing result of the VCS section 30 of its own office at the step S38 described in the first embodiment (the address information obtained as the input result of the information input device 33 or the processing result of the offline OCR 35) may be subjected to the processing shown in FIG. 10 described in the second embodiment. In consequence, the VCS section 30 including the offline OCR 35 can efficiently be operated in the whole system, and the efficient update of the address information database can be promoted.

Moreover, the first and third embodiments are combined and implemented, whereby the address information stored in the address information database can be evaluated for each district while efficiently operating the offline OCR. For example, the processing result of the VCS section 30 of its own office at the step S38 described in the first embodiment (the address information obtained as the input result of the information input device 33 or the recognition result of the offline OCR 35) may be subjected to the processing of the steps S224 to S227 shown in FIG. 14 described in the third embodiment. In consequence, the VCS section 30 including the offline OCR 35 can efficiently be operated in the whole system, and the efficient update of the address information database can be promoted.

Furthermore, the second and third embodiments are combined and implemented, whereby the address information stored in the address information database is evaluated, and the address information required to be updated can easily be updated based on the data of the individual file or the data integrated in the whole file. For example, the processing of the steps S145 to S150 described in the second embodiment and the processing of the steps S225 to S227 described in the third embodiment may successively or simultaneously be executed. In consequence, it is possible to prepare the file (the individual file or the whole file) of the data on the address information which is not registered in the address information database together with the data for evaluating the address information database. As a result, the efficient update of the address information database can be promoted.

According to one configuration of this invention, processing of sorting paper sheets based on sort information can efficiently be performed.

What is claimed is:

1. A paper sheets processing device comprising:
a database in which various pieces of character information including specific character strings are stored;
a reading section which reads images of paper sheets;
a first recognizing section which recognizes the character information applied to the paper sheets from the images of the paper sheets read by this reading section;
a collating section which collates the character information as a recognition result of this first recognizing section with each character information stored in the database;
a judging section which judges, based on a processing situation of another paper sheets processing device that performs data communication with the paper sheets processing device, whether or not the images of the paper sheets are transferred to the other paper sheets processing device, in a case where this collating section judges that the character information as the recognition result of the first recognizing section does not match any character information stored in the database;
a second recognizing section which recognizes the character information applied to the paper sheets from the images of the paper sheets by a process different from that of the first recognizing section, in a case where this judging section judges that the images of the paper sheets are not transferred; and
a transfer section which transfers, to the other paper sheets processing device, the images of the paper sheets judged to be transferred by the judging section.

2. The device according to claim 1, wherein the judging section judges whether or not to transfer the images of the paper sheets, based on an installation situation of the second recognizing section in the other paper sheets processing device, in a case where the collating section judges that the character information as the recognition result of the first recognizing section does not match the character information stored in the database.

3. The device according to claim 1, wherein the judging section judges whether or not to transfer the images of the paper sheets, based on an operating situation of the second recognizing section in the other paper sheets processing device, in a case where the collating section judges that the character information as the recognition result of the first recognizing section does not match the character information stored in the database.

4. The device according to claim 1, wherein the judging section judges whether or not to transfer the images of the paper sheets, based on precision of the database of the other paper sheets processing device, in a case where the collating section judges that the character information as the recognition result of the first recognizing section does not match the character information stored in the database.

5. The device according to claim 1, wherein the respective pieces of character information stored in the database are various pieces of beforehand specified address information, and
the first and second recognizing sections recognize the address information from the images of the paper sheets read by the reading section.

6. The device according to claim 5, wherein the respective pieces of address information include first information indicating a district and second information indicating a place in the district, and
in a case where the collating section judges that the character information as a recognition result of the first recognizing section does not match the character information stored in the database, when the first recognizing section recognizes the first information of the address information, the judging section judges whether or not to transfer the images of the paper sheets to another paper sheets processing device that processes the paper sheets of the district indicated by the first information.

7. The device according to claim 1, further comprising:
an information input section which allows input of the character information applied to the paper sheets in a state in which the images of the paper sheets read by the reading section are displayed, in a case where the character information as a recognition result of the second recognizing section does not match any character information stored in the database;
a judging section which judges whether or not the character information input by the information input section matches the character information stored in the database; and
a filing section which forms a file of the images of the paper sheets together with the character information input by the information input section, in a case where the judging section judges that the character information input by the information input section does not match any character information stored in the database.

8. The device according to claim 1, further comprising:
an information input section which allows input of the character information applied to the paper sheets in a state in which the images of the paper sheets read by the reading section are displayed, in a case where the second recognizing section does not recognize any character information; and
a total section which totals the number of cases where the character information input by this information input section matches the character information recognized by the second recognizing section.

9. A paper sheets processing device comprising:
a database in which various pieces of character information including specific character strings are stored;
a reading section which reads images of paper sheets;
an information input section which allows input of the character information applied to the paper sheets in a state in which the images of the paper sheets read by this reading section are displayed;
a judging section which judges whether or not the character information input by this information input section matches the character information stored in the database; and
a filing section which forms a file of the images of the paper sheets together with the character information input by the information input section, in a case where this judging section judges that the character information input by the information input section does not match any character information stored in the database.

10. The device according to claim 9, further comprising:
a recognizing section which recognizes the character information applied to the paper sheets from the images of the paper sheets read by the reading section; and
a judging section which judges whether or not the character information recognized by the recognizing section matches the character information stored in the database,
wherein in a case where the judging section judges that the character information recognized by the recognizing section does not match any character information stored in the database, the information input section inputs the character information applied to the paper sheets.

11. The device according to claim 9, further comprising:
a transmitting section which transmits the file formed by the filing section to a transmission destination specified by a part of the address information filed by the filing section.

12. The device according to claim 9, further comprising:
a processing section which reorganizes a plurality of files formed by the filing section into one file for each group specified based on a part of the address information filed by the filing section.

13. The device according to claim 9, further comprising:
a judging section which judges whether or not the character information input by the information input section matches the character information as a recognition result of the reading section; and
a total section which totals the number of cases where this judging section judges that the character information input by the information input section matches the character information recognized by the recognizing section.

14. A paper sheets processing device comprising:
a database in which various pieces of character information including specific character strings are stored;
a reading section which reads images of paper sheets;
a recognizing section which recognizes the character information applied to the paper sheets from the images of the paper sheets read by this reading section;
a collating section which collates the character information as a recognition result of this recognizing section with each character information stored in the database;
an information input section which allows input of the character information applied to the paper sheets, in a case where this collating section judges that the character information as the recognition result of the recognizing section does not match any of the various pieces of character information stored in the database;
a judging section which judges whether or not the character information input by this information input section matches the character information as the recognition result of the recognizing section; and
a total section which totals the number of cases where this judging section judges that the character information input by the information input section matches the character information recognized by the recognizing section.

15. The device according to claim 14, further comprising:
a first processing section which processes the paper sheets based on the character information as the recognition result of the recognizing section, in a case where the collating section judges that the character information as the recognition result of the recognizing section matches the character information stored in the database; and
a second processing section which processes the paper sheets based on the character information input by the information input section, in a case where the collating section judges that the character information as the recognition result of the recognizing section does not match any character information stored in the database

16. The device according to claim 15, wherein the respective pieces of character information stored in the database are various pieces of beforehand specified address information,
the recognizing section recognizes the address information from the images of the paper sheets read by the reading section,
the first processing section sorts the paper sheets based on the address information as the recognition result of the recognizing section, and
the second processing section sorts the paper sheets based on the address information input by the information input section.

17. The device according to claim 16, wherein the address information includes first information indicating a district and second information indicating a place in the district, and
the total section totals the number of cases where it is judged that the address information input by the information input section matches the address information recognized by the recognizing section, for each district identified in accordance with the first information.

18. A paper sheets processing method comprising:
reading images of paper sheets;
recognizing, by a first recognizing process, character information applied to the paper sheets from the read images of the paper sheets;
collating the character information as a recognition result with various pieces of character information stored in a database and including specific character strings;
judging, based on a situation of another paper sheets processing device that performs data communication with the paper sheets processing device, whether or not to transfer the images of the paper sheets to the other paper sheets processing device, in a case where this collation judges that the character information as the recognition result of the first recognizing process does not match any character information stored in the database;
recognizing the character information applied to the paper sheets from the images of the paper sheets by a second recognizing process different from the first recognizing process, in a case where this judgment judges that the images of the paper sheets are not transferred; and
transferring, to the other paper sheets processing device, the images of the paper sheets judged to be transferred by the judgment.

19. A paper sheets processing method comprising:
reading images of paper sheets;
allowing input of character information applied to the paper sheets in a state in which the read images of the paper sheets are displayed;
judging whether or not the input character information matches any of various pieces of character information stored in a database and including specific character strings; and
forming a file of the input character information together with the read images of the paper sheets, in a case where this judgment judges that the input character information does not match any character information stored in the database.

20. A paper sheets processing method comprising:
reading images of paper sheets;
recognizing character information applied to the paper sheets from the read images of the paper sheets;
collating the character information as a recognition result with various pieces of character information stored in a database and including specific character strings;
allowing input of the character information applied to the paper sheets, in a case where this collation judges that the recognized character information does not match any character information stored in the database;
judging whether or not this input character information matches the recognized character information; and
totaling the number of cases where this judgment judges that the input character information matches the recognized character information.
